(19) United States
(12) Patent Application Publication
(10) Pub. No.: US 2007/0298214 A1
(43) Pub. Date: Dec. 27, 2007

(54) NONWOVEN FABRIC

(75) Inventors: Yuki NODA, Kagawa (JP); Hideyuki ISHIKAWA, Kagawa (JP); Satoshi MIZUTANI, Kagawa (JP); Akihiro KIMURA, Kagawa (JP)

Correspondence Address: LOWE HAUPTMAN HAM & BERNER, LLP, 1700 DIAGONAL ROAD, SUITE 300, ALEXANDRIA, VA, 22314, US

(73) Assignee: UNI-CHARM CORPORATION, Shikokuchuo-shi (JP)

(21) Appl. No.: 11/751,782

(22) Filed: May 22, 2007

(30) Foreign Application Priority Data
Jun. 23, 2006 (JP) 2006-174505
Sep. 8, 2006 (JP) 2006-244767

(51) Int. Cl. B32B 3/10; D04H 13/00

(52) U.S. Cl. 428/138; 428/131; 428/219; 442/334

(57) ABSTRACT

A nonwoven fabric having a predetermined strength against line tension is provided. A nonwoven fabric includes first regions, second regions, and third regions, in plural, wherein the second regions are arranged on both sides of the first regions, and the third regions are arranged on sides opposite to the first regions side of the second regions. The first regions have the highest content ratio of laterally orientated fibers, and the second regions have the highest content ratio of longitudinally orientated fibers.

This application is based on and claims the benefit of priority from Japanese Patent Application No. 2006-174505, filed on 23 Jun. 2006 and Japanese Patent Application No. 2006-244767, filed on 8 Sep. 2006, the content of which is incorporated herein by reference.

### BACKGROUND OF THE INVENTION

1. Field of the Invention

The present invention relates to a nonwoven fabric.

2. Related Art

Conventionally, nonwoven fabrics have been used in a wide range of fields: sanitary articles such as disposable diapers and sanitary napkins; cleaning articles such as wipers; and medical supplies such as masks. As described above, nonwoven fabrics have been used in various different fields; however, it is necessary to manufacture them so as to have properties and structures suitable for the application of each product if they are actually to be used for products in each field.

Nonwoven fabrics are manufactured by way of, for example, forming a fiber layer (fiber web) by means of a dry method, a wet process, or the like, and bonding fibers in the fiber layer to each other by means of a chemical bonding method, a thermal bonding method, or the like. In a process of bonding the fibers used for forming the fiber layer, methods of applying external physical force to the fiber layer, such as a method of repeatedly sticking multiple needles into the fiber layer, a method of jetting streams of water, and other related methods, exist.

Nevertheless, the aforementioned methods are merely used for interlacing fibers, and not for adjusting the orientation and location of fibers in a fiber layer, the shape of the fiber layer, or the like. Basically, mere sheet-shaped nonwoven fabrics have been manufactured by means of these aforementioned methods.

In addition, it is desirable that an uneven nonwoven fabric or the like be used as a nonwoven fabric to be used for a top sheet or the like of an absorbent articles in order to keep or improve its feel to the skin when fluid such as an excretory substance or the like is absorbed into the absorbent articles in use. Moreover, a nonwoven fabric on the surface of which concavity and convexity are formed due to heat shrinkage of at least one of a plurality of fiber layers caused by stacking and heat-sealing the plurality of fiber layers made of fibers with different heat shrinkability, and a manufacturing method for the same are disclosed in Japanese Patent Publication No. 3587831 (hereinafter referred to as Patent Document 1).

Nevertheless, the nonwoven fabric disclosed in Japanese Patent Document 1 has a problem in that the nonwoven fabric is stretched by application of line tension in the manufacturing process and the concavity and convexity, formed on the nonwoven fabric are crushed, or heights of convex portions are made lower than the original heights, when the nonwoven fabric is used for other products such as a top sheet of an absorbent articles.

In this case, the nonwoven fabric disclosed in Patent Document is a nonwoven fabric, which includes second fiber layers containing heat shrinkable fibers stacked on either side of a first fiber layer formed of fibers containing non-heat shrinkable fibers, and integrated with each other by means of multiple heat-sealed portions through hot embossing. More specifically, the nonwoven fabric is one configured so that multiple raised portions configured with the first fiber layer are formed on non-heat sealed regions, and heat-sealed portions become concave portions by heat shrinking the second fiber layer horizontally after hot embossing.

In this nonwoven fabric, the multiple raised portions are formed on the first fiber layer due to heat shrinkage of the second fiber layers; however, shrinkage develops in a horizontal direction in heat shrinkage of the second fiber layer. In short, there is a problem in that when line tension is applied to the nonwoven fabric in the manufacturing process of a product for which this nonwoven fabric is used, the second fiber layers are easily stretched out, and the raised portions on the first fiber layers are then stretched out, or the heights of the raised portions may be made lower than the original heights.

### SUMMARY OF THE INVENTION

To solve the abovementioned problems, the objective of the present invention is to provide a nonwoven fabric whose fiber orientation is adjusted so as to have a predetermined strength even if line tension is applied.

The inventors have found that regarding at least fiber orientation, a plurality of regions with different content ratios of longitudinally orientated fibers may be formed by directing a jet of gas onto a fiber web from the topside, which is supported from the underside by a predetermined breathable supporting member to shift fibers constituting the fiber web, thereby completing the present invention.

In a first aspect of the present invention, a nonwoven fabric having a first direction and a second direction orthogonal to the first direction, includes: a plurality of first regions, a plurality of second regions which are formed along both sides of the plurality of respective first regions; and a plurality of third regions which are formed on sides opposite to the plurality of first regions in the plurality of respective second regions, and between the plurality of respective second regions adjacent to each other, the nonwoven fabric characterized in that the plurality of respective first regions have a higher content ratio of fibers orientated in the second direction than the plurality of respective third regions, and the plurality of respective second regions have a higher content ratio of fibers orientated in the first direction than the plurality of respective third regions.

In a second aspect of the nonwoven fabric described in the first aspect, the content ratio of fibers orientated in the first direction in the plurality of respective third regions is from 40% to 80%, a content ratio of fibers orientated in the first direction in the plurality of respective first regions is not greater than 45%, and at least 10% lower than a content ratio of fibers orientated in the first direction in the plurality of respective third regions, and a content ratio of fibers orientated in the first direction in the plurality of respective second regions is at least 55%, and at least 10% higher than the content ratio of fibers orientated in the first direction in the plurality of respective third regions.

In a third aspect of the nonwoven fabric described in the first or second aspect, a content ratio of fibers orientated in the second direction in the plurality of respective first regions is at least 55%.

In a fourth aspect of the nonwoven fabric described in any one of the first to third aspects, a fiber basis weight in the plurality of respective first regions is from 3 to 150 g/m², a fiber basis weight in the plurality of respective second regions is from 20 to 280 g/m², and a fiber basis weight in the plurality of respective third regions is from 15 to 250 g/m².

In a fifth aspect of the nonwoven fabric described in any one of the first to fourth aspects, a fiber density in the plurality of respective first regions is not greater than 0.18 g/cm³, a fiber density in the plurality of respective second regions is not greater than 0.40 g/cm³, and a fiber density in the plurality of respective third regions is not greater than 0.20 g/cm³.

In a sixth aspect of the nonwoven fabric described in any one of the first to fifth aspects, the respective heights in a thickness direction in the plurality of first regions, the plurality of second regions, and the plurality of third regions in the nonwoven fabric substantially equal.

In a seventh aspect of the nonwoven fabric described in any one of the first to fifth aspects, a plurality of grooves, and a plurality of convex portions, which is formed to be adjacent to the plurality of respective grooves, are formed in the nonwoven fabric, the plurality of respective first regions constitutes the plurality of respective grooves, the plurality of respective second regions constitutes side portions of the plurality of convex portions, and the plurality of respective third regions constitutes central portions in the plurality of convex portions.

In an eighth aspect of the nonwoven fabric described in the seventh aspect, the heights of the grooves in the nonwoven fabric in a thickness direction are not greater than 90% the heights of the central portions of the convex portions, and the heights of the side portions of the convex portions are not greater than 95% the heights of the central portions of the convex portions.

In a ninth aspect of the nonwoven fabric described in the seventh or eighth aspects, a fiber basis weight in the plurality of respective grooves is not greater than 90% the average fiber basis weight in the plurality of convex portions.

In a tenth aspect of the nonwoven fabric described in any one of the seventh to ninth aspects, the heights of the plurality of respective convex portions adjacent to each other sandwiching the plurality of respective grooves differ.

In an eleventh aspect of the nonwoven fabric described in any one of the seventh to tenth aspects, the crown portion of the plurality of respective convex portions are substantially flat.

In a twelfth aspect of the nonwoven fabric described in any one of the seventh to eleventh aspects, a plurality of regions protruding to a side opposite to a protrusion direction of the convex portions is formed on a side opposite to a side on which the plurality of grooves and the plurality of convex portions in the nonwoven fabric are formed.

In a thirteenth aspect of the nonwoven fabric described in any one of the first to sixth aspects, a plurality of openings is formed in the plurality of respective first regions.

In a fourteenth aspect of the nonwoven fabric described in the thirteenth aspect, the fibers in the periphery of the plurality of respective openings are orientated to be along the respective peripheries of the plurality of respective openings.

In a fifteenth aspect of the nonwoven fabric described in any one of the first to fourteenth aspects, the nonwoven fabric is mixed with water-repellent fibers.

In a sixteenth aspect of the present invention, the nonwoven fabric described in any one of the first to fifteenth aspects, includes wavy undulations in the first direction.

### EFFECTS OF THE INVENTION

To solve the abovementioned problems, the objective of the present invention is to provide a nonwoven fabric whose fiber orientation is at least adjusted so as to have predetermined strength even if line tension is applied.

### BRIEF DESCRIPTION OF THE DRAWINGS

FIG. 1 is a perspective view of a fiber web;

FIGS. 2A and 2B show a top view and a bottom view of a nonwoven fabric of a first embodiment;

FIG. 3 is a magnified perspective view of an area X of FIG. 2;

FIGS. 4A and 4B show a top view and a perspective view of a netted supporting member;

FIG. 5 is a diagram showing that the nonwoven fabric of the first embodiment in FIG. 2 is manufactured by directing a jet of gas onto the topside while the underside of the fiber web of FIG. 1 is supported by the netted supporting member of FIG. 4;

FIG. 6 is a side view illustrating a nonwoven fabric manufacturing device of the first embodiment;

FIG. 7 is a top view illustrating the nonwoven fabric manufacturing device of FIG. 6;

FIG. 8 is a magnified perspective view of an area Z of FIG. 6;

FIG. 9 is a bottom view of the blowing nozzles of FIG. 8;

FIG. 10 is a magnified perspective view of a nonwoven fabric of a second embodiment;

FIG. 11 is a magnified perspective view of a nonwoven fabric of a third embodiment;

FIG. 12 is a perspective view of a netted supporting member of the third embodiment;

FIG. 13 is a magnified perspective view of a nonwoven fabric of a fourth embodiment;

FIG. 14 is a magnified perspective view of a nonwoven fabric of a fifth embodiment;

FIG. 15 is a magnified perspective view of a nonwoven fabric of a sixth embodiment; and

FIGS. 16A and 16B show a top view and a perspective view of a supporting member of the sixth embodiment.

### DETAILED DESCRIPTION OF THE INVENTION

Preferred embodiments of the present invention are described below while referring to the drawings.

### 1-1

The nonwoven fabric according to this embodiment is a nonwoven fabric which is adjusted to include a plurality of first regions, a plurality of second regions, which is formed along both sides of the plurality of first regions, and a plurality of third regions, each of which is formed between adjacent second regions on the opposite side to the side on which the plurality of first regions in the plurality of second regions is formed. In addition, the nonwoven fabric is a nonwoven fabric which is configured so that the content ratio of the laterally orientated fibers, that is, fibers orientated in a second direction or width direction (WD), in the first regions is higher than those in the third regions; and the content ratio of longitudinally orientated fibers, that is, fibers orientated in a first direction or longitudinal direction (LD), in the second regions is higher than those in the third regions.

### 1-2. First Embodiment

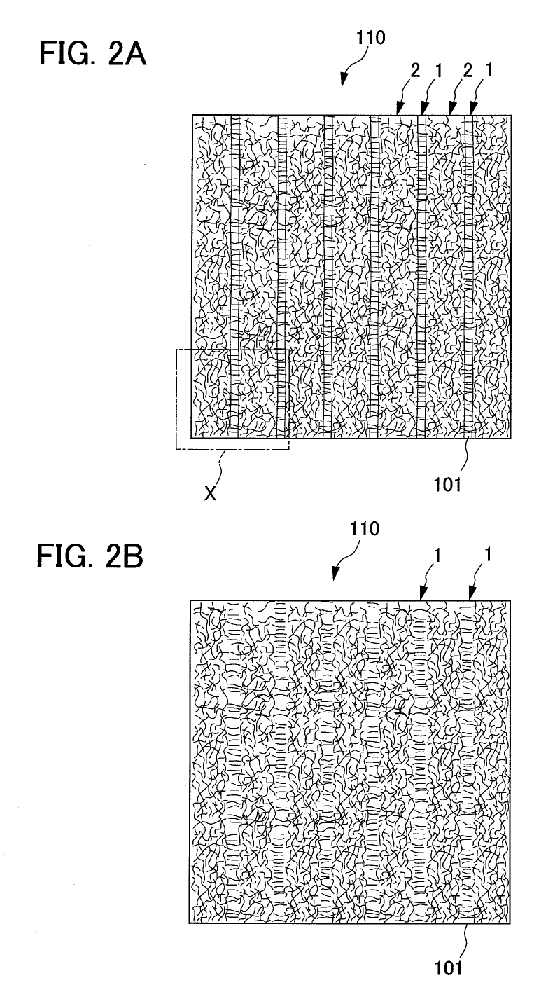

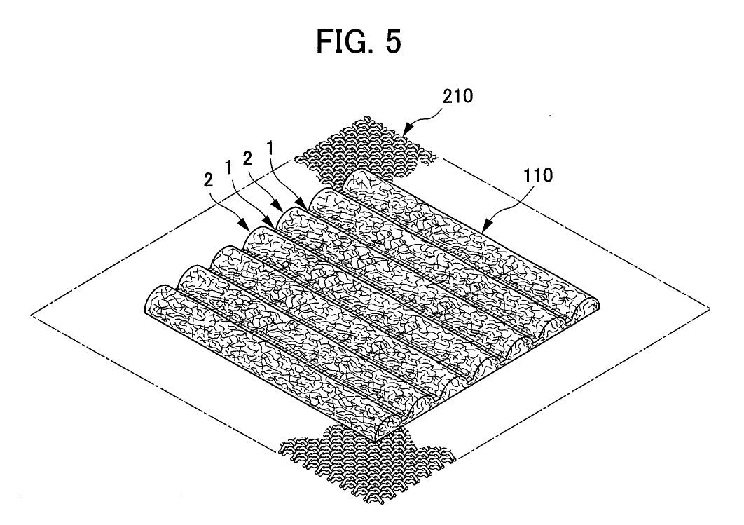

A nonwoven fabric according to a first embodiment of the present invention is described below while referring to FIGS. 2 to 5.

### 1-2-1. Shapes

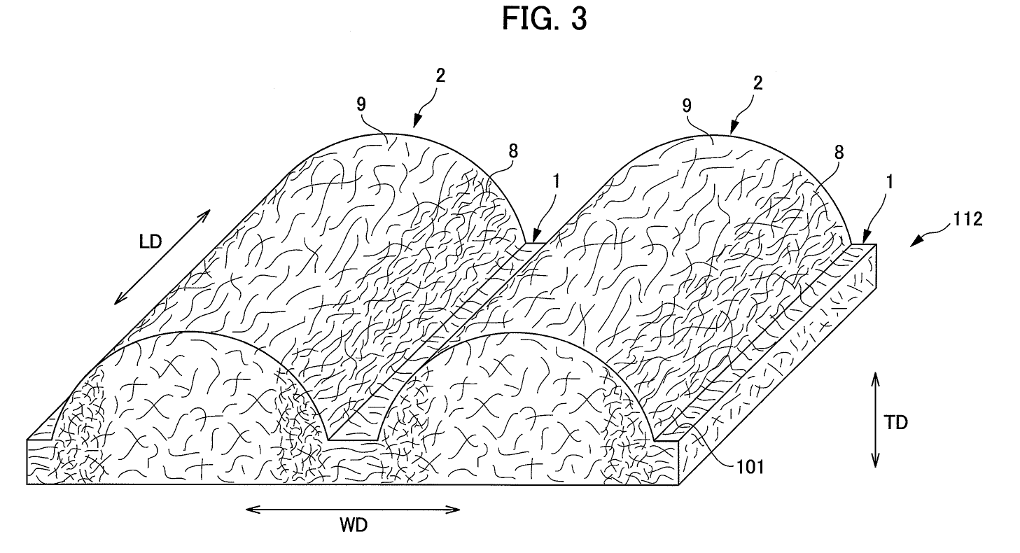

As shown in FIGS. 2A, 2B, and 3, a nonwoven fabric 110 according to this embodiment is a nonwoven fabric which is formed so that a plurality of grooves 1 or first regions is formed substantially parallel at substantially equal intervals in a longitudinal direction (LD) on one side of the nonwoven fabric 110. In addition, a plurality of convex portions 2, which is constituted with second regions and third regions, is formed between the plurality of respective grooves 1 formed at substantially equal intervals. The convex portions 2 are formed in parallel at substantially equal intervals as with the grooves 1.

In the case of this embodiment, the grooves 1 are formed in parallel at substantially equal intervals, but are not limited thereto. For example, the grooves 1 may be formed at different intervals; or may be formed not in parallel, but so that the intervals between the grooves 1 vary. In addition, the same applies to the convex portions.

Moreover, the heights (thickness direction (TD)) of the convex portions 2 of the nonwoven fabric 110 according to this embodiment are substantially equal; however, the heights of the convex portions 2 adjacent to each other, for example, may be formed to be different from each other. For example, the heights of the convex portions 2 may be adjusted by adjusting the intervals of blowing nozzles 913, which are described later, from which fluid mainly consisting of gas is ejected. For example, the heights of the convex portions 2 may be lowered by narrowing the intervals of the blowing nozzles 913; on the contrary, the heights of the convex portions 2 may be heightened by widening the intervals of the blowing nozzles 913. Moreover, the convex portions 2 differing in height may be formed alternately by forming the intervals of the blowing nozzles 913 so as to alternate narrow intervals and wide intervals. In addition, as described above, there is an advantage in that a partial change in the heights of the convex portions 2 allows for a reduction in the area in contact with the skin, allowing for a reduction in the strain to the skin.

The convex portion 2 of the nonwoven fabric 110 according to this embodiment is constituted with the side portions 8 or second regions, and the central portions 9 or third regions. The height of the nonwoven fabric 110 in the thickness direction (TD) in the central portions 9 may be exemplified as being from 0.3 to 15 millimeters, preferably 0.5 to 5 millimeters. In addition, the lengths in a width direction (WD) of the central portions 9 are from 0.5 to 30 millimeters, preferably 1.0 to 10 millimeters. Moreover, the distance between the central portions 9 adjacent to each other sandwiching the side portions 8 and the grooves 1 may be exemplified as being from 0.5 to 30 millimeters, preferably 3 to 10 millimeters.

In addition, the height of the nonwoven fabric 110 in the thickness direction (TD) in the side portions 8 may be exemplified as being at most 95%, preferably 50 to 90% of the heights of the central portions 9. Moreover, the lengths in the width direction (WD) of the side portions 8 are from 0.1 to 10 millimeters, preferably 0.3 to 5.0 millimeters. Furthermore, the distance between the side portions 8 adjacent to each other via either the central portions 9 or the grooves 1 may be exemplified as being from 0.1 to 20 millimeters, preferably 0.5 to 10 millimeters.

In addition, the height of the nonwoven fabric 110 in the thickness direction (TD) in the grooves 1 is at most 90%, preferably 1 to 50%, more preferably 5 to 20%, of the height in the thickness direction (TD) in the central portions 9. The lengths in the width direction (WD) of the grooves 1 may be exemplified as being from 0.1 to 30 millimeters, preferably 0.5 to 10 millimeters. The distance between the grooves 1 adjacent to each other via the convex portions 2 is from 0.5 to 20 millimeters, preferably 3 to 10 millimeters.

Such a design allows for the formation of the grooves 1 suitable for preventing a considerable amount of predetermined fluids from spreading and running together, even if the fluids are excreted when the nonwoven fabric 110 is used as a top sheet of an absorbent article. In addition, spaces formed by the grooves 1 may easily be maintained, even when the convex portions 2 are crushed due to excessive external pressure applied to the nonwoven fabric 110. Moreover, it is possible to prevent predetermined fluids from spreading and running together, even if the fluids are excreted while external pressure is applied to the nonwoven fabric 110. Furthermore, formation of concavity and convexity on the surface of the nonwoven fabric 110 reduces the area in contact with the skin, even if the predetermined fluids once absorbed by an absorber or the like are reversed under the external pressure. This may allow for the prevention of broad adherence of fluids to the skin.

In this case, a measuring method for height, pitch, and width of the grooves 1 or the convex portions 2 is as follows. For example, the nonwoven fabric 110 is placed on a table in an unpressurized state, and measurement is carried out from a cross-sectional photo or a cross-sectional image of the nonwoven fabric 110 using a microscope. It should be noted that boundaries of the central portions 9, the side portions 8, and the grooves 1 are determined on the basis of a range of ratio of longitudinally orientated fibers to laterally orientated fibers in each portion.

To measure the heights (lengths in the thickness direction (TD)), the respective highest positions of the central portions 9, the side portions 8, and the grooves 1 formed upward from the lowest position (i.e., surface of the table) of the nonwoven fabric 110 are measured as the heights.

In addition, the distances between the central positions of the respective adjacent central portions 9 are measured as the pitches between the central portions 9 adjacent to each other. Similarly, the distances between the central positions of the adjacent side portions 8 are measured as the pitches between the side portions 8 adjacent to each other; the distances between the central positions of the adjacent grooves 1 are measured as the pitches between the grooves 1 adjacent to each other.

To measure the widths of the central portions 9, the maximum width of the bottom of the central portions 9 upward from the lowest position (i.e., the surface of the table) of the nonwoven fabric 110 is measured. The side portions 8 and the grooves 1 are measured in the same manner.

In this case, the cross-sectional shapes of the convex portions 2 are not particularly limited. For example, a dome shape, a trapezoidal shape, a triangular shape, an ohmic shape, a square shape, or the like may be exemplified. It is preferable that the vicinity of the topsides and side faces of the convex portions 2 are curved surfaces in order to improve the feel thereof. In addition, it is also preferable that the widths from the undersides to the topsides of the convex portions 2 are narrow in order to maintain spaces formed by the grooves 1, even if the convex portions 2 are crushed by an external pressure. A curved line (curved surface) such as a substantially dome shape or the like may be exemplified as a preferred shape of the convex portion 2.

### 1-2-2. Fiber Orientation

As illustrated in FIG. 3, the nonwoven fabric 110 includes regions with respective different content ratio of longitudinally orientated fibers, that is, fibers 101 are orientated in a longitudinal direction (LD) or a direction along regions onto which a jet of fluid mainly containing gas is directed. The grooves 1 or the first regions, the side portions 8 or the second regions, and the central portions 9 or the third regions may be exemplified as the respective different regions.

In this case, the fibers 101 are orientated in a longitudinal direction (LD) means that the fibers 101 are orientated within a range of plus 45 degrees to minus 45 degrees with respect to the longitudinal direction (LD); fibers orientated in the longitudinal direction (LD) are called longitudinally orientated fibers. In addition, the fibers 101 are orientated in a width direction (WD) means that the fibers 101 are orientated within a range of plus 45 degrees to minus 45 degrees with respect to the width direction (WD); and fibers orientated in the width direction (WD) are called laterally orientated fibers.

The side portions 8 are regions corresponding to both sides of the convex portions 2, and the fibers 101 in the side portions 8 are formed so that more fibers (longitudinally orientated fibers) orientated in the longitudinal direction (LD) of the convex portions 2 are contained. For example, more fibers are orientated in the longitudinal direction (LD) than orientation of the fibers 101 in the central portions 9 of the convex portions 2 (regions between two adjacent side portions 8 in the convex portions 2). The content ratio of the longitudinally orientated fibers in the side portions 8 may be exemplified as being from 55 to 100%, more preferably 60 to 100%. If the content ratio of the longitudinally orientated fibers is less than 55%, the side portions 8 may be stretched due to line tension. In addition, the grooves 1 and the central portions 9, which is described later, may also be stretched due to line tension since the side portions 8 are stretched.

The central portions 9 are regions between the side portions 8 or both sides of the convex portions 2, and regions where the content ratio the longitudinally orientated fibers is less than those in the side portions 8. It is preferable that the longitudinally orientated fibers and the laterally orientated fibers are moderately mixed in the central portions 9.

For example, the content ratio of the longitudinally orientated fibers in the central portions 9 is made to be at least 10% lower than the content ratio in the side portions 8, and at least 10% higher than the content ratio of the longitudinally orientated fibers at the bottom of the grooves 1. More specifically, it is preferable that the content ratio of the longitudinally orientated fibers is within a range from 40 to 80%.

Since the grooves 1 are regions onto which a jet of fluid mainly containing gas (e.g., hot air) is directed, the fibers 101 orientated in the longitudinal direction (LD) are driven to the side portions 8. As a result, the fibers orientated in the width direction (WD) remain at the bottom of the grooves 1, and thus the fibers 101 at the bottom of the grooves 1 contain more of the laterally orientated fibers than the longitudinally orientated fibers.

For example, the content ratio of the longitudinally orientated fibers in the grooves 1 may be exemplified as being at least 10% lower than the content ratio of the longitudinally orientated fibers in the central portions 9. Accordingly, at the bottom of the grooves 1, the content ratio of the longitudinally orientated fibers of the nonwoven fabric 110 are the lowest, and the content ratio of the laterally orientated fibers is the highest. More specifically, it is preferable that the content ratio of the longitudinally orientated fibers is from zero to less than 45%, preferably zero to 40%. If the content ratio of the longitudinally orientated fibers is more than 45%, it becomes difficult to improve the strength of the nonwoven fabric in the width direction (WD) because the fiber basis weight in the grooves 1 is low, as described hereafter. Therefore, if the nonwoven fabric 110 is used as the top sheet of an absorbent article, for example, a twist in the width direction (WD) or damage due to bodily friction may occur during use of the absorbent article.

Measurement of fiber orientation was carried out using a digital microscope VHX-100 manufactured by Keyence Corporation, according to the following measuring method. (1) A sample was set on an observation table so that the longitudinal direction (LD) was longitudinal, (2) a lens was then focused on the nearest fiber of the sample except for the fibers irregularly protruding forward, (3) photographing depth (depth) was set and a three-dimensional image of the sample was then drawn on a PC screen. Next, (4) the three-dimensional image was transformed into a two-dimensional image, and (5) multiple parallel lines which equally divide the longitudinal direction (LD) at appropriate times within a measurement range were then drawn on the screen. (6) Fiber orientation was observed in each cell segmented by drawing parallel lines to determine whether it was in the longitudinal direction (LD) or in the width direction (WD), and the number of fibers orientated in each direction was then measured. Afterwards, (7) a ratio of the number of fibers orientated in the longitudinal direction (LD) and a ratio of the number of fibers orientated in the width direction (WD) with respect to the total number of fibers within a specified range were calculated, thereby allowing for measurement and calculation.

### 1-2-3. Fiber Density

As illustrated in FIG. 3, the grooves 1 are adjusted so that fiber density of the fibers 101 is lower than that in the convex portions 2. In addition, the fiber density in the grooves 1 may be adjusted as needed according to various conditions such as the amount of fluid mainly containing gas (e.g., hot air), tension, and the like. The fiber density at the bottom of the grooves 1 may be exemplified as being at most 0.18 g/cm³, preferably 0.002 to 0.18 g/cm³, more preferably 0.005 to 0.05 g/cm³. If the fiber density at the bottom of the grooves 1 is lower than 0.002 g/cm³, the nonwoven fabric 110 may easily be damaged when the nonwoven fabric 110 is used for an absorbent article or the like, for example. In addition, if the fiber density at the bottom of the grooves 1 is higher than 0.18 g/cm³, fluid accumulates in the bottom of the grooves 1 since it becomes difficult to shift the fluid downward, and thus, moistness may be felt by the user.

As mentioned above, the convex portions 2 are adjusted so that the fiber density of the fibers 101 is higher than that in the grooves 1. In addition, the fiber density in the convex portions 2 may be adjusted as needed according to various conditions such as the amount of fluid mainly containing gas (e.g., hot air), tension, and the like.

Moreover, the side portions in the convex portions 2 may be adjusted as needed according to various conditions such as the amount of fluid mainly containing gas (e.g., hot air), tension, and the like.

The fiber density in the central portions 9 of the convex portions 2 may be exemplified as being from 0 to 0.20 g/cm³, preferably 0.005 to 0.20 g/cm³, more preferably 0.007 to 0.07 g/cm³. If the fiber density in the central portions 9 is lower than 0.005 g/cm³, not only are the central portions 9 easily crushed due to the own weight of the fluid contained in the central portions 9 and external pressure, but also once absorbed fluid may easily be desorbed under pressure. In addition, if the fiber density in the central portions 9 is higher than 0.20 g/cm³, it becomes difficult to shift fluid brought to the central portions 9 downward, the fluid accumulates in the central portions 9, and thus feeling of moistness may be felt by users.

Moreover, the fiber density in the side portions 8 may be adjusted as needed according to various conditions such as the amount of fluid mainly containing gas (e.g., hot air), line tension to be applied during manufacturing the nonwoven fabric 110, and the like. More specifically, the fiber density in the side portions 8 may be exemplified as being from 0 to 0.40 g/cm³, preferably 0.007 to 0.25 g/cm³, more preferably 0.01 to 0.20 g/cm³. If the fiber density in the side portions 8 is lower than 0.007 g/cm³, the side portions 8 may be stretched due to line tension. In addition, if the fiber density in the side portions 8 is higher than 0.40 g/cm³, fluid is accumulated in the side portions 8 since it becomes difficult to shift the fluid downward, and thus, feeling of moistness may be felt by the user.

### 1-2-4. Fiber Basis Weight

As illustrated in FIG. 3, fiber basis weight of the fibers 101 at the bottom of the grooves 1 is adjusted so as to be lower than that in the convex portions 2. In addition, the fiber basis weight at the bottom of the grooves 1 is adjusted to be lower than the average fiber basis weight of the entire nonwoven fabric 110 including the grooves 1 and the convex portions 2.

As mentioned above, the average fiber basis weight of the fibers 101 in the convex portions 2 is adjusted to be higher than that at the bottom of the grooves 1. In addition, the fiber basis weight in the grooves 1 is adjusted to be lower than the average fiber basis weight of the entire nonwoven fabric 110 including the grooves 1 and the convex portions 2.

The average fiber basis weight of the entire nonwoven fabric 110 may be exemplified as being, for example, from 10 to 200 g/m², preferably 20 to 100 g/m². When the nonwoven fabric 110 is used as the top sheet of an absorbent article, for example, if the average fiber basis weight is lower than 10 g/m², the top sheet may easily be damaged during use. In addition, if the average fiber basis weight of the nonwoven fabric 110 is higher than 200 g/m², it may become difficult to smoothly shift fluid downward.

As illustrated in FIG. 3, the fiber basis weight of the fibers 101 at the bottom of the grooves 1 is adjusted to be lower than that in the convex portions 2. In addition, the fiber basis weight in the grooves 1 is adjusted to be lower than the average fiber basis weight of the entire nonwoven fabric, including the grooves 1 and the convex portions 2. More specifically, the fiber basis weight at the bottom of the grooves 1 may be exemplified as being from 3 to 150 g/m², preferably 5 to 80 g/m². When the nonwoven fabric is used as the top sheet of the absorbent article, for example, if the fiber basis weight at the bottom of the grooves 1 is lower than 3 g/m², the top sheet may easily be damaged during use of the absorbent article. In addition, if the fiber basis weight at the bottom of the grooves 1 is higher than 150 g/m², fluid accumulates in the grooves 1 since it becomes difficult to shift fluid brought to the grooves 1 downward, and thus, feeling of moistness may be felt by the user.

As mentioned above, the average fiber basis weight of the fibers 101 in the convex portions 2 is adjusted to be higher than that in the grooves 1. The fiber basis weight in the central portions 9 in the convex portions 2 may be exemplified as being, for example, from 15 to 250 g/m², preferably 20 to 120 g/m². If the fiber basis weight in the central portions 9 is lower than 15 g/m², not only are the central portions 9 easily crushed due to the fluid's own weight contained in the central portions 9 and external pressure, but also once absorbed fluid may easily be desorbed under pressure. In addition, if the fiber basis weight in the central portions 9 is higher than 250 g/m², it becomes difficult to shift brought fluid downward, the fluid accumulates in the central portions 9, and thus, feeling of moistness may be felt by the user.

Moreover, the fiber basis weight in the side portions 8 or the side portions of the convex portions 2 may be adjusted as needed according to various conditions such as the amount of fluid mainly containing gas (e.g., hot air), line tension to be applied during manufacturing, and the like. More specifically, the fiber basis weight in the side portions 8 may be exemplified as being from 20 to 280 g/m², preferably 25 to 150 g/m². If the fiber basis weight in the side portions 8 is lower than 20 g/m², the side portions 8 may be stretched due to line tension applied during manufacturing. In addition, if the fiber basis weight in the side portions 8 is higher than 280 g/m², fluid brought to the side portions 8 accumulates in the side portions 8 since it becomes difficult to shift the fluid downward, and thus, feeling of moistness may be felt by the user.

In addition, the fiber basis weight at the bottom of the grooves 1 is adjusted to be lower than the average fiber basis weight in the entire convex portions 2 constituted with the side portions 8 and the central portions 9. For example, the fiber basis weight at the bottom of the grooves 1 may be exemplified as being 90% or less, preferably 3 to 90%, and more preferably 3 to 70%, than the average fiber basis weight in the convex portions 2. If the fiber basis weight at the bottom of the grooves 1 is 90% higher than the average fiber basis weight in the convex portions 2, the resistance when the fluid fallen into the grooves 1 shifts downwards may increase, and the fluid may flow out of the grooves 1. In addition, if the fiber basis weight at the bottom of the grooves 1 is 3% lower than the average fiber basis weight in the convex portions 2, when the nonwoven fabric is used as a top sheet of an absorbent article, the top sheet may easily be damaged during use of the absorbent article.

### 1-2-5. Other

When the nonwoven fabric of this embodiment is used to absorb or pass through a predetermined fluid, for example, the grooves 1 allow the fluid to pass through, and it is difficult for the convex portions 2 to hold the fluid since it is a porous structure.

Since the fiber density and the fiber basis weight at the bottom of the grooves 1 are both low, the bottom portions are suitable for passing through the fluid. Moreover, since the fibers 101 at the bottom of the grooves 1 are orientated in the width direction (WD), it is possible to prevent the fluid from flowing excessively and spreading widely in the longitudinal direction (LD) of the grooves 1. Since the fibers 101 in the grooves 1 are orientated in the width direction (WD), regardless of whether the fiber basis weight in the grooves 1 is low, the strength of the nonwoven fabric in the width direction (WD) increases.

The nonwoven fabric 110 is adjusted so that the average fiber basis weight in the convex portions 2 is high; however, this increases the number of fibers, increases the number of sealing points, and maintains the porous structure. Furthermore, in the convex portions 2, the side portions 8, in which the fiber basis weight and the fiber density are adjusted to be higher than those of the central portions 9, are formed so as to support the central portions 9 of the convex portions 2. In short, since most of the fibers 101 in the side portions 8 are orientated in the longitudinal direction (LD), the distance between fibers decreases, increasing the fiber density and solidity. This makes the side portions 8 support the entire convex portions 2, and prevents crushing of the convex portions 2 due to external pressure or the like.

In addition, the content of the laterally orientated fibers per unit area in the grooves 1 is higher than those in the central portions 9; and the content of the longitudinally orientated fibers per unit area in the side portions 8 is higher than those in the central portions 9. In addition, more of the fibers 101 orientated in a thickness direction (TD) are contained in the central portions 9 than in the grooves 1 and the side portions 8. Accordingly, the convex portions 2 may easily recover to their original heights depending on the solidity of the fibers 101 orientated in the thickness direction (TD) when load is released even if, for example, the thickness of the convex portions 2 decreases when the load is applied to the central portions 9. Basically, it is possible to form a nonwoven fabric with high compression recoverability.

### 1-2-6. Manufacturing Method

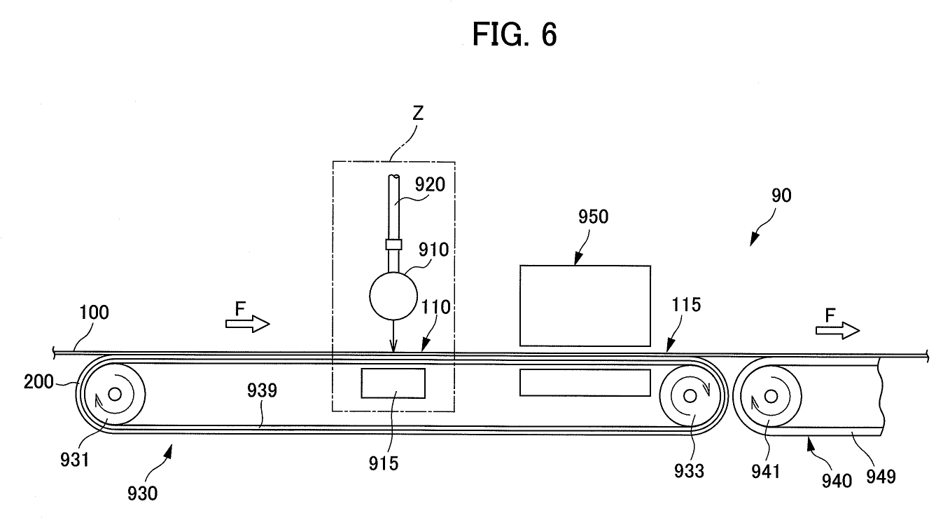

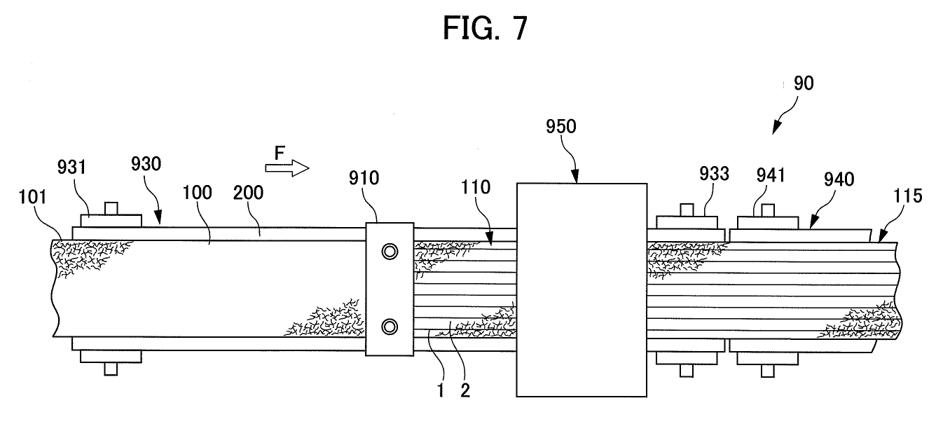

As illustrated in FIGS. 6 to 9, a manufacturing method of a nonwoven fabric 110 according to this embodiment is described below. Initially, a fiber web 100 is placed on the topside of a netted supporting member 210 or a breathable supporting member. In other words, the fiber web 100 is supported by the netted supporting member 210 from below.

It is preferable that the fibers 101 constituting the fiber web 100 are in a parallel orientation. Parallel orientation means an orientation in which a ratio of fibers orientated in the longitudinal direction (LD) in the entire fiber web is at least 50%, more preferably 60 to 95%. It is possible to make the fibers 101 in a parallel orientation by pulling the fiber web 100 through adjusting line tension or the like until the fibers are rearranged by directing a jet of air (gas) flow onto the fiber web 100 formed by a carding method.

As illustrated in FIGS. 6 through 9, a nonwoven fabric manufacturing device 90, which manufactures the nonwoven fabric 110 of this embodiment, is constituted with a breathable supporting member 200, which supports the fiber web 100 or fiber assembly from one side, an blowing unit 910 and an air supplying unit, not shown in the drawing, all of which constitute a directing means for directing a jet of fluid mainly containing gas from the other side of the fiber web 100 or the fiber assembly onto the fiber web 100 or the fiber assembly supported by the breathable supporting member 200 from the one side, and a conveyer 930, which is a shifting means for shifting the fiber web 100 or the fiber assembly in a predetermined direction F.

The breathable supporting member 200 is, for example, a supporting member that allows the fluid mainly containing gas passed through the fiber web 100 or fluid mainly containing gas ejected from the blowing unit 910 in FIG. 6 to pass through to the opposite side to the side on which the fiber web 100 is placed.

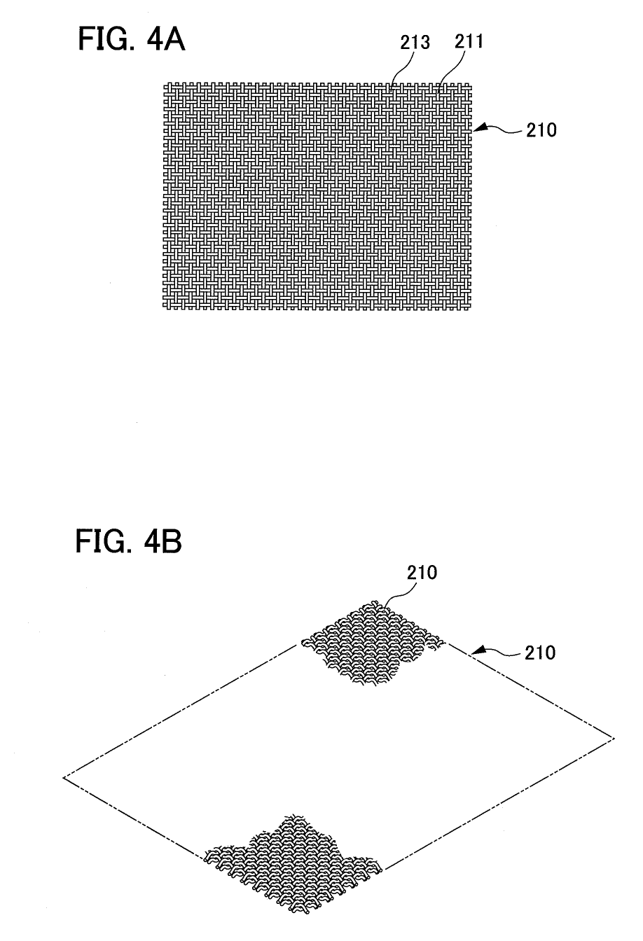

The netted supporting member 210 as shown in FIG. 4, for example, may be exemplified as the breathable supporting member 200 used in this embodiment. The netted supporting member 210 is formed so that a plurality of impervious wires 211 with a predetermined size is woven. A netted supporting member in which a plurality of openings 213 or vents is formed is provided by weaving the plurality of wires 211 at predetermined intervals.

The nonwoven fabric 110 of this embodiment may be manufactured by shifting the netted supporting member 210 to a predetermined direction while supporting the fiber web 100, and continuously directing a jet of fluid mainly containing gas from the topside of the fiber web 100 which is being shifted.

In the netted supporting member 210 of FIG. 4, as mentioned above, a plurality of small openings 213 is formed, and a jet of fluid mainly containing gas directed from the topside of the fiber web 100 passes downwardly through without being impeded by the netted supporting member 210. The netted supporting member 210 does not largely change the flow of fluid mainly containing gas to be directed thereupon, and prevents shifting of the fibers 101 down the netted supporting member 210.

Therefore, the fibers 101 in the fiber web 100 are shifted in a predetermined direction by fluid mainly containing gas directed thereupon mainly from the topside. More specifically, the fibers 101 are shifted in a direction along the surface of the netted supporting member 210 since shifting down the netted supporting member 210 is controlled.

For example, the fibers 101 in regions onto which a jet of fluid mainly containing gas is directed are shifted to regions adjacent to those regions. In addition, since the regions onto which a jet of fluid mainly containing gas is directed are shifted in a predetermined direction, a result is that the fibers 101 are shifted to side regions in the regions onto which a jet of fluid mainly containing gas is directed and which continue in the predetermined direction.

Through this, the grooves 1 are formed, longitudinally orientated fibers at the bottom of the grooves 1 are shifted to the side portions 8 sides (both sides of the grooves 1) of the convex portions 2, and the laterally orientated fibers at the bottom of the grooves are left in the grooves 1. This orientates the fibers at the bottom of the grooves 1 in a width direction (WD) on the whole. In addition, the longitudinally orientated fibers shifted from the grooves 1 are driven to the side portions 8 in the convex portions 2. Accordingly, the fiber density in the side portions 8 in the convex portions 2 increases and the side portions 8 in which the fibers 101 are orientated in the longitudinal direction (LD) on the whole are formed.

In this case, the fiber web 100 is formed while being sequentially shifted by means of the shifting means in the nonwoven fabric manufacturing device 90. The shifting means shifts the fiber web 100 or fiber assembly in a predetermined direction while being supported by the aforementioned breathable supporting member 200 from one side. More specifically, the fiber web 100 onto which a jet of fluid mainly containing gas is being directed is shifted in the predetermined direction F. The conveyer 930 shown in FIG. 6, for example, may be exemplified as the shifting means. The conveyer 930 is constituted with a breathable belt 939 on which the breathable supporting member 200 is placed and which is formed in a horizontal ring shape, and rotors 931 and 933, which are placed on the inside of the breathable belt 939 formed in a horizontal ring shape on both ends in the longitudinal direction (LD), rotate the ring-shaped breathable belt 939 in a predetermined direction.

As mentioned above, the conveyer 930 shifts the netted supporting member 210 in the predetermined direction F, while supporting the fiber web 100 from the underside. More specifically, as illustrated in FIG. 6, the fiber web 100 is shifted so as to pass under the blowing unit 910. Moreover, the fiber web 100 is shifted to pass through the inside of a heater 950, which is a heating means with both side faces opened.

The directing means is configured with the air supplying unit not shown in the drawing and the blowing unit 910. The air supplying unit not shown in the drawing is connected to the blowing unit 910 via an air-pipe 920. The air-pipe 920 is connected to the top side of the blowing unit 910 to allow ventilation. As illustrated in FIG. 9, blowing nozzles 913 are formed in plural at predetermined intervals in the blowing unit 910.

Gas supplied from the air supplying unit, not shown in the drawing, to the blowing unit 910 via the air-pipe 920 is ejected from the plurality of blowing nozzles 913 formed in the blowing unit 910. The gas ejected from the plurality of blowing nozzles 913 is continuously directed onto the topside of the fiber web 100, which is supported by the netted supporting member 210 from the underside. More specifically, the gas ejected from the plurality of blowing nozzles 913 is continuously directed onto the topside of the fiber web 100, which is being shifted in the predetermined direction F by the conveyer 930.

An air intake unit 915, which is placed below the blowing unit 910 or on the underside of the netted supporting member 210, takes in gas and the like, which are ejected from the blowing unit 910 and pass through the netted supporting member 210. In this case, it is possible to position the fiber web 100 to be attached to the netted supporting member 210 by taking in air through the air intake unit 915. In addition, air intake allows for prevention of deformation of the fiber web 100 shape because fluid mainly containing gas, which hits the wires 211 of the netted supporting member 210, deflects, and conveying to the inside of the heater 950 while further keeping the shape of grooves (concavity and convexity) and the like formed by airflow. In this case, it is preferable that conveying is carried out while drawing air into the heater 950 simultaneously with the forming by airflow.

Suction by the air intake unit 915 may be performed with intensity so that fibers 101 in regions onto which a jet of fluid mainly containing gas is directed are pressed to the netted supporting member 210.

The temperature of fluid mainly containing gas ejected from the respective blowing nozzles 913 and mainly contains gas, may be at room temperature, as mentioned above; however, it may be adjusted to be at least equal to or above a softening point of the thermoplastic fibers constituting the fiber assembly, and preferably a temperature above the softening point and can be regulated 50 degrees centigrade above and 50 degrees centigrade below the melting point. Since the repulsive force of the fibers themselves decreases when the fibers are softened, the shape of the fibers rearranged by airflow or the like may be easily maintained, and the shape of the grooves (concavity and convexity) and the like may be further easily maintained since heat-sealing between fibers begins when the temperature is further raised. This makes it easier to convey to the inside of the heater 950 while maintaining the shape of the grooves (concavity and convexity) and the like.

It should be noted that the shape of the convex portions 2 may be changed by adjusting airflow, temperature, and intake amount of the directed fluid mainly containing gas, breathability of the netted supporting member 210, the fiber basis weight of the fiber web 100, and the like. For example, if the amount of directed fluid mainly containing gas and the intake amount of fluid mainly containing gas are almost equal or the intake amount of fluid mainly containing gas is more, the undersides of the convex portions 2 in the nonwoven fabric 110 are formed along the shape of the netted supporting member 210. Accordingly, if the netted supporting member 210 is flat, the underside of the nonwoven fabric 110 is substantially flat.

To convey the fiber web 100 to the heater 950 while further maintaining the shape of the grooves (concavity and convexity) in the fiber web 100 and the like formed by airflow or the like, it is possible to convey the fiber web 100 to the inside of the heater 950 just after or simultaneous with forming of the grooves (concavity and convexity) and the like by airflow or the like, or to convey the fiber web 100 to the heater 950 after cooling by cold air or the like just after forming of the grooves (concavity and convexity) and the like by hot air (airflow at a predetermined temperature).

Both ends of the heater 950 or a heating means are opened in the predetermined direction F. This continuously shifts the fiber web 100 (nonwoven fabric 110) placed on the breathable supporting member 200 to be shifted by the conveyer 930 through a heating space formed within the heater 950 while holding it for a predetermined period of time. For example, if thermoplastic fibers are included in the fibers 101 constituting the fiber web 100 (nonwoven fabric 110), it is possible to provide a nonwoven fabric 115 in which the fibers 101 are combined together by heating in the heater 950.

### 2. OTHER EMBODIMENTS

A nonwoven fabric according to other embodiments of the present invention is described below. It should be noted that the description of the same parts as with the nonwoven fabric according to the first embodiment is omitted, and the same reference numerals are used in the drawings as with the first embodiment.

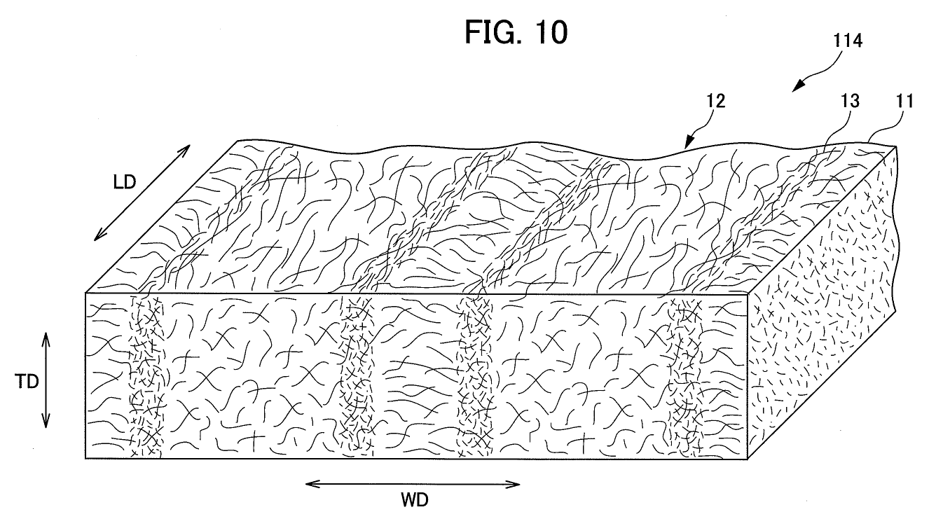

A nonwoven fabric according to a second through a sixth embodiment of the present invention is described below while referring to FIGS. 10 to 16. The second embodiment is another embodiment regarding a shape of the nonwoven fabric. The third embodiment is another embodiment regarding a configuration of the nonwoven fabric. The fourth embodiment is another embodiment regarding a configuration of the nonwoven fabric. The fifth embodiment is another embodiment regarding convex portions and grooves. The sixth embodiment is another embodiment regarding hole formation for the nonwoven fabric.

### 2-1. Second Embodiment

### 2-1-1 Shape

As illustrated in FIG. 10, a nonwoven fabric 114 according to this embodiment is a nonwoven fabric of which both surfaces are substantially flat. In addition, it is a nonwoven fabric on which regions with different fiber orientations and the like in predetermined regions are formed. Differences from the first embodiment are mainly described below.

### 2-1-2. Fiber Orientation

As illustrated in FIG. 10, a plurality of regions with different content ratios of longitudinally orientated fibers is formed in the nonwoven fabric 114. In the nonwoven fabric 114, longitudinally orientated portions 13 or second regions with the highest content ratio of longitudinally orientated fibers, central portions 12 or third regions with a lower content ratio of longitudinally orientated fibers than those in the longitudinally orientated portions 13, and laterally orientated portions 11 or first regions with the lowest content ratio of longitudinally orientated fibers and the highest content ratio of laterally orientated fibers may be exemplified as the plurality of regions with different content ratios of longitudinally orientated fibers. In addition, a plurality of longitudinally orientated portions 13 is formed along both sides of a plurality of laterally orientated portions 11 in the nonwoven fabric 114. Moreover, a plurality of central portions 12 are located at the side portions opposite to the laterally orientated portions 11 side in the plurality of longitudinally orientated portions 13, and formed on regions sandwiched by the adjacent longitudinally orientated portions 13, respectively.

The laterally orientated portions 11 are regions which are formed of remaining fibers 101 after the fibers 101 orientated in a longitudinal direction (LD) or a longitudinal direction in a fiber web 100 are driven to the longitudinally orientated portions 13 side by fluid mainly containing gas. Basically, since the fibers 101 orientated in the longitudinal direction (LD) are shifted to the longitudinally orientated portions 13 by fluid mainly containing gas, laterally orientated fibers orientated mainly in the width direction (WD) or a lateral direction remain in the laterally orientated portions 11. Accordingly, most of the fibers 101 in the laterally orientated portions 11 are orientated in a direction (width direction (WD)) intersecting the longitudinal direction (LD). Although the laterally orientated portions 11 are adjusted so that the fiber basis weight becomes low, as described later, the tensile strength in the width direction (WD) increases since a majority of the fibers 101 in the laterally orientated portions 11 is orientated in the width direction (WD). This allows for prevention of damage even if a force such as friction is applied in the width direction (WD) during use when the nonwoven fabric 114 is used, for example, as a top sheet of an absorbent article.

In addition, the longitudinally orientated portions 13 are formed when the fibers 101, which are orientated in the longitudinal direction (LD) in the fiber web 100, are driven to the longitudinally orientated portions 13 side by directing a jet of fluid mainly containing gas thereupon. Moreover, since most of the fibers 101 in the longitudinally orientated portions 13 are orientated in the longitudinal direction (LD), the inter-fiber distances of the respective fibers 101 become short, increasing fiber density. This also increases solidity.

### 2-1-3. Fiber Density

As illustrated in FIG. 10, the fibers 101 in the laterally orientated portions 11 are shifted because a jet of fluid mainly containing gas is directed thereupon, and the fibers 101 are shifted together to the underside in the thickness direction (TD) of the nonwoven fabric 114 by pressure of the directed jet of fluid mainly containing gas. Accordingly, the space-area ratio on the topside in the thickness direction (TD) of the nonwoven fabric 114 is high, and the space-area ratio on the underside is low. In other words, fiber density on the topside in the thickness direction (TD) of the nonwoven fabric 114 is high, and fiber density on the underside is low.

The laterally orientated portions 11 are formed so that fiber density is low since the fibers 101 in the laterally orientated portions 11 are shifted when fluid mainly containing gas is directed thereupon. On the other hand, the longitudinally orientated portions 13 are regions in which the fibers 101 shifted from the laterally orientated portions 11 gather, and thus, are formed so that fiber density is higher than that in the laterally orientated portions 11. Fiber density in the central portions 12 is formed so as to be between the fiber density in the laterally orientated portions 11 and the fiber density in the longitudinally orientated portions 13.

### 2-1-4. Fiber Basis Weight

As illustrated in FIG. 10, the fiber basis weight in the laterally orientated portions 11 becomes the lowest because the fibers 101 are shifted into other regions by a jet of fluid mainly containing gas directed onto the laterally orientated portions 11. In addition, the fiber basis weight in the longitudinally orientated portions 13 becomes the highest because the fibers 101 shifted from the laterally orientated portions 11 are driven by the fluid mainly containing gas. The central portions 12 are then formed so that both sides are sandwiched by the longitudinally orientated portions 13. Basically, since the longitudinally orientated portions 13 with high fiber basis weight are formed on both sides of the central portions 12 and the laterally orientated portions 11, which are regions with low fiber basis weight, it is possible to prevent stretching due to line tension or the like during manufacturing of the nonwoven fabric 114, even if fiber basis weight is low.

### 2-1-5. Other

If the nonwoven fabric 114 is used as a top sheet of an absorbent article, for example, it is possible to use the nonwoven fabric 114 while maintaining the laterally orientated portions 11 and the central portions 12 with low fiber basis weight; that is, while preventing stretching due to line tension or the like during product manufacturing. In addition, since the longitudinally orientated portions 13 with high fiber basis weight are formed between the laterally orientated portions 11 and the central portions 12, respectively, it becomes difficult for the nonwoven fabric 114 to be crushed due to the weight of the fluid or its own weight when containing fluid or the like. Accordingly, it is possible to shift fluid downward in the nonwoven fabric 114 while preventing the spread of fluid on the surface, even if fluid is repeatedly excreted.

### 2-1-6. Manufacturing Method

A manufacturing method of the nonwoven fabric 114 according to this embodiment is described below. Initially, a fiber web 100 is placed on the topside of a netted supporting member 210 or a breathable supporting member. That is, the fiber web 100 is supported by the netted supporting member 210 from below. The same netted supporting member 210 as the netted supporting member 210 according to the first embodiment may be used.

The nonwoven fabric 114 of this embodiment may be manufactured by shifting the netted supporting member 210 in a predetermined direction while supporting the fiber web 100, and continuously directing a jet of fluid mainly containing gas from the topside of the fiber web which is being shifted.

The amount of directed fluid mainly containing gas onto the nonwoven fabric 114 should be enough to allow shift of fibers 101 of the fiber web 100 in a width direction (WD) in regions onto which the jet of fluid mainly containing gas is directed. In this case, it is preferable that drawing is not carried out by an air intake unit 915 which draws the directed fluid mainly containing gas to the underside of the netted supporting member 210; however, drawing may be carried out to the extent that the laterally orientated portions 11 are not pressed against the netted supporting member 210.

In addition, a nonwoven fabric with concavity and convexity such as grooves, convex portions 2, or the like may be formed by directing a jet of fluid mainly containing gas, and the formed concavity and convexity then crushed by wrapping the nonwoven fabric into a roll or the like.

Moreover, since the fibers 101 in regions onto which a jet of fluid mainly containing gas is directed are shifted while being pressed against the netted supporting member 210 side by drawing the fluid mainly containing gas from the underside of the netted supporting member 210, fibers gather at the netted supporting member 210 side. Furthermore, in the central portions 12 and the longitudinally orientated portions 13, fibers are partially orientated in a thickness direction (TD) because the directed fluid mainly containing gas collides with the netted supporting member 210 and deflects.

The nonwoven fabric 114 according to this embodiment may be manufactured by means of the aforementioned nonwoven fabric manufacturing device 90. A description of the manufacturing method for the nonwoven fabric 110 and the nonwoven fabric manufacturing device 90 according to the first embodiment may serve as a reference for a manufacturing method and the like for the nonwoven fabric 114 by means of the nonwoven fabric manufacturing device 90.

### 2-2. Third Embodiment

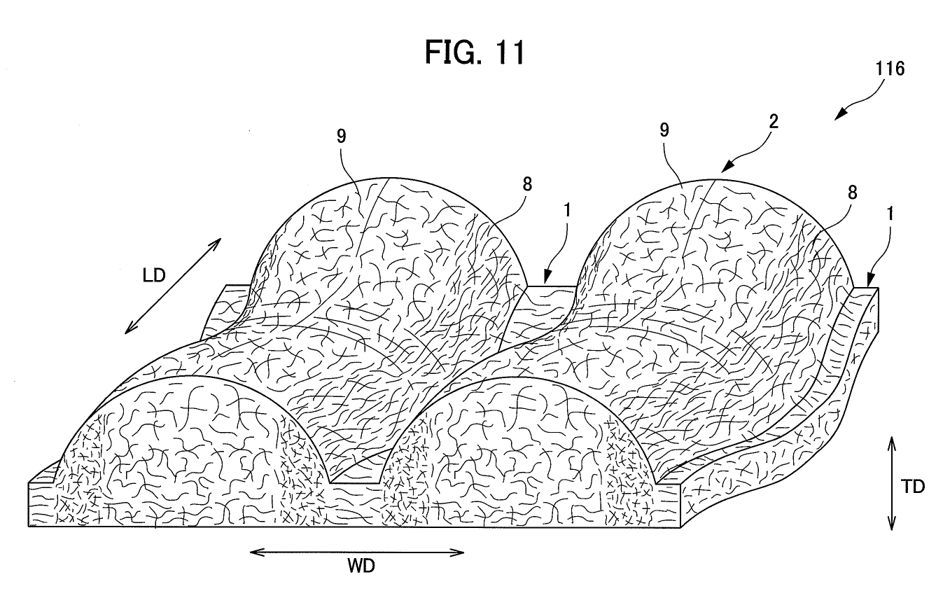

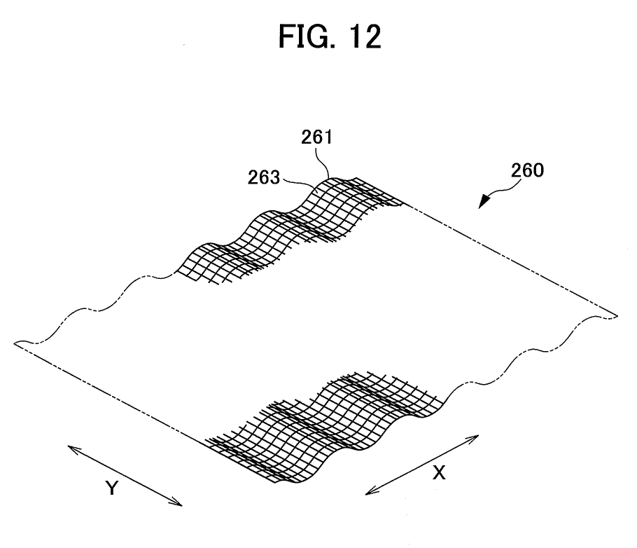

A nonwoven fabric according to the third embodiment of the present invention is described below while referring to FIGS. 11 and 12.

### 2-2-1. Nonwoven Fabric

As illustrated in FIGS. 11 and 12, a nonwoven fabric 116 according to this embodiment is different from the first embodiment in that the entire nonwoven fabric 116 has alternating undulations in a longitudinal direction (LD). The differences are mainly described below.

The nonwoven fabric 116 according to this embodiment is formed so that the entire nonwoven fabric 116 has wavy undulations substantially orthogonal to the direction in which grooves 1 and convex portions 2 extend.

### 2-2-2. Manufacturing Method

The nonwoven fabric 116 according to this embodiment may be formed in the same manner as the first embodiment; however, the shape of a netted supporting member 260 or a breathable supporting member 200 differs. The netted supporting member 260 of this embodiment is formed so that a plurality of wires 261 with a predetermined size, which is an impervious portion, is woven together. A netted supporting member in which a plurality of openings 263 or vents are formed may be provided by weaving the plurality of wires 261 at predetermined intervals.

In addition, the netted supporting member 260 is a supporting member which has wavy undulations in a direction parallel to either the longitudinal direction or the lateral direction of the netted supporting member 260. In this embodiment, as illustrated in FIG. 12, for example, it is formed so as to have wavy alternating undulations in a direction parallel to a Y axis.

As mentioned above, the netted supporting member 260 of FIG. 12 includes the plurality of small openings 263, and gas directed thereupon from the topside of the fiber web 100 passes downwardly through without being impeded by the netted supporting member 260. The netted supporting member 260 does not considerably change the flow of directed fluid mainly containing gas, and prevents the fibers 101 from shifting down the netted supporting member 260.

In addition, since the netted supporting member 260 has wavy undulations, the fiber web 100 is formed in a shape having undulations along the shape of the netted supporting member 260 due to the fluid mainly containing gas being directed from the topside of the fiber web 100.

The nonwoven fabric 116 of this embodiment may be formed by shifting the fiber web 100 along an X axis while directing a jet of fluid mainly containing gas onto the fiber web 100 placed on the topside of the netted supporting member 260.

The undulating pattern of the netted supporting member 260 may be specified as needed. For example, a pitch between top points of the undulations along the X axis shown in FIG. 12 may be exemplified as being from 1 to 30 millimeters, preferably 3 to 10 millimeters. In addition, differences in height between the top points and bottom points of the undulations of the netted supporting member 260 may be exemplified as being, for example, from 0.5 to 20 millimeters, preferably 3 to 10 millimeters. Moreover, as illustrated in FIG. 12, a cross-sectional shape along the X axis of the netted supporting member 260 is not limited to a wave form, and may be exemplified as a row of approximate triangles so that the respective peaks of the top points and bottom points of the undulations make an acute angle, a row of concavity and convexity of approximate rectangles so that the respective peaks of the top points and bottom points of the undulations are substantially flat, and the like.

The nonwoven fabric 116 according to this embodiment may be manufactured by means of the aforementioned nonwoven fabric manufacturing device 90. The description of the manufacturing method for the nonwoven fabric 110 and the nonwoven fabric manufacturing device 90 according to the first embodiment may serve as a reference for a manufacturing method and the like of the nonwoven fabric 116 by means of the nonwoven fabric manufacturing device 90.

### 2-3. Fourth Embodiment

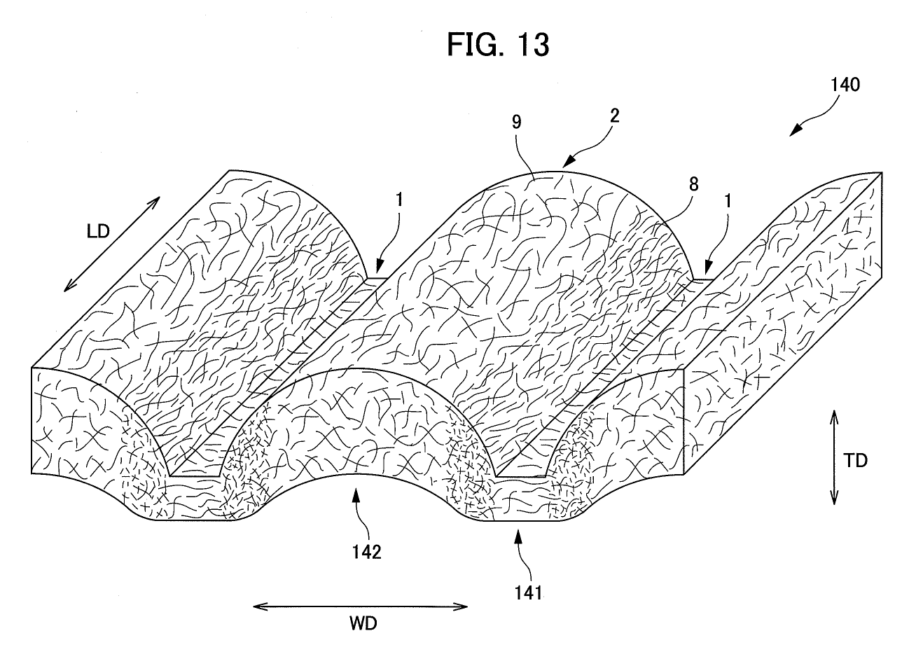

A nonwoven fabric according to the fourth embodiment of the present invention is described below while referring to FIG. 13.

As illustrated in FIG. 13, a nonwoven fabric 140 according to this embodiment is different from the first embodiment in a pattern of a side opposite to a side on which grooves 1 and convex portions 2 of the nonwoven fabric 140 are formed. In addition, differences from the first embodiment are mainly described below.

### 2-3-1. Nonwoven Fabric

The grooves 1 and the convex portions 2 are formed alternately in parallel on one side of the nonwoven fabric 140 of this embodiment. In addition, on the other side of the nonwoven fabric 140, regions corresponding to the bottoms of the convex portions 2 are formed so as to be convex against the side to which the convex portions 2 protrude. In other words, in the nonwoven fabric 140, regions corresponding to the bottoms of the convex portions 2 on the one side sink in and form concave portions on the other side of the nonwoven fabric 140. In addition, regions corresponding to the bottoms of the grooves 1 on the one side protrude out and form convex portions.

### 2-3-2. Manufacturing Method

A manufacturing method of the nonwoven fabric 140 according to this embodiment is the same as that described in the aforementioned first embodiment. In addition, a supporting member used for manufacturing the nonwoven fabric 140 may be the same as the netted supporting member 210 of the aforementioned first embodiment.

In this embodiment, a fiber web 100 is placed on a netted supporting member 210, and the fiber web 100 is shifted in a predetermined direction while directing a jet of fluid mainly containing gas thereupon, and the fluid mainly containing gas to be directed is suctioned (drawn) from below the netted supporting member 210. The amount of fluid mainly containing gas suctioned (drawn) is made less than the amount of fluid mainly containing gas directed. In this way, if the amount of fluid mainly containing gas directed is more than the amount of fluid mainly containing gas suctioned (drawn), the directed fluid mainly containing gas collides with the netted supporting member 210 or a breathable supporting member and slightly deflects, for example. In addition, the fluid mainly containing gas deflected off of the netted supporting member 210 passes through from the underside to the topside of the convex portions 2. This forms the underside (bottom side) of the convex portions 2 so as to protrude in the same direction as the topside of the convex portions 2.

The nonwoven fabric 140 according to this embodiment may be manufactured by means of the aforementioned nonwoven fabric manufacturing device 90. The description of the manufacturing method for the nonwoven fabric 110 and the nonwoven fabric manufacturing device 90 according to the first embodiment may serve as a reference for a manufacturing method and the like of the nonwoven fabric 140 by means of the nonwoven fabric manufacturing device 90.

### 2-4. Fifth Embodiment

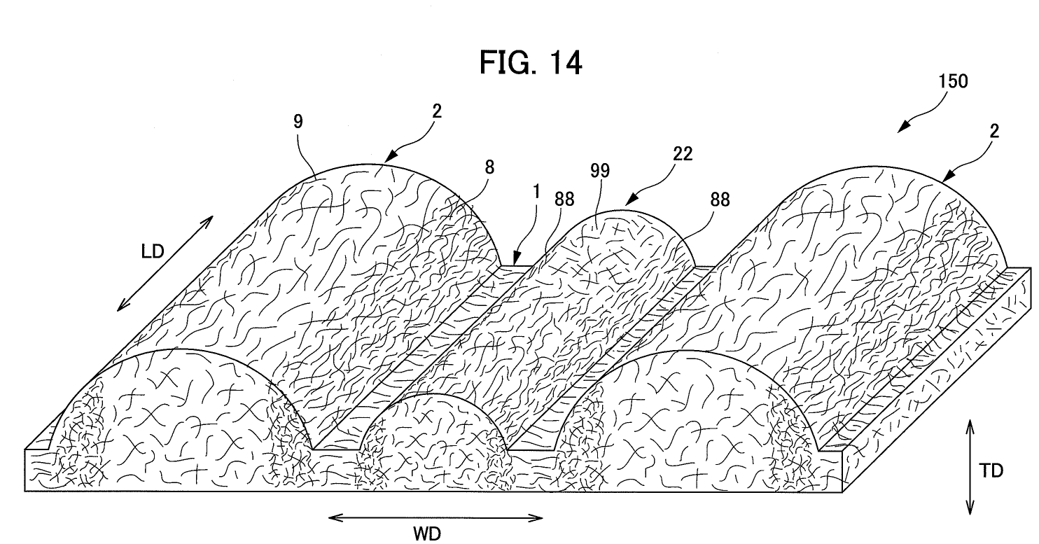

A nonwoven fabric according to the fifth embodiment of the present invention is described below while referring to FIG. 14.

As illustrated in FIG. 14, a nonwoven fabric 150 according to this embodiment is different from the aforementioned first embodiment in that the second convex portions 22 with different heights in a thickness direction (TD) than the convex portions 2 formed on one side of the nonwoven fabric 150 are formed. The differences from the first embodiment are mainly described below.

### 2-4-1. Nonwoven Fabric

The nonwoven fabric 150 is a nonwoven fabric in which a plurality of grooves 1 is formed in parallel on one side. In addition, a plurality of convex portions 2 is formed between the plurality of respective grooves 1 formed at substantially equal intervals. Moreover, a plurality of second convex portions 22 are formed alternately sandwiching the plurality of respective grooves 1 between the plurality of respective convex portions 2, which are adjacent to each other sandwiching the plurality of grooves 1. In other words, the convex portions 2 and the second convex portions 22 are formed alternately in parallel sandwiching the plurality of respective grooves 1.

The convex portions 2 and the second convex portions 22 are regions in a fiber web 100 onto which fluid mainly containing gas is not directed, and are relatively protruding regions since the grooves 1 are formed. The second convex portions 22 are formed so that, for example, the heights in a thickness direction (TD) are lower than the convex portions 2 and the lengths in a width direction (WD) are less in the nonwoven fabric 150; however, fiber density, fiber orientation, fiber basis weight, and the like in the second convex portions 22 are the same as those in the convex portions 2.

Regarding the arrangement of the convex portions 2 and the second convex portions 22 in the nonwoven fabric 150, the convex portions 2 and the second convex portions 22 are formed between the plurality of respective grooves 1 formed in parallel. In addition, the convex portions 2 are formed to be adjacent to the second convex portions 22 sandwiching the grooves 1. Conversely, the second convex portions 22 are formed so as to be adjacent to the convex portions 2 sandwiching the grooves 1. Basically, the convex portions 2 and the second convex portions 22 are formed alternately sandwiching the grooves 1. More specifically, the convex portion 2, the groove 1, the second convex portion 22, the groove 1, and the convex portion 2 are repeatedly formed in this order. It should be noted that the positional relationship between the convex portions 2 and the second convex portions 22 is not limited to this, and at least a part of the nonwoven fabric 150 may be formed such that a plurality of respective convex portions 2 are adjacent to each other sandwiching the grooves 1. Furthermore, at least a part of the nonwoven fabric 150 may be formed such that a plurality of respective second convex portions 22 are adjacent to each other and sandwiching the grooves 1.

### 2-4-2. Manufacturing Method

A manufacturing method for the nonwoven fabric 150 according to this embodiment is similar to the description of the first embodiment; however, a shape of blowing nozzles 913 of a nonwoven fabric manufacturing device 90 used for manufacturing the nonwoven fabric 150 differs.

The nonwoven fabric 150 is formed by shifting a fiber web 100 in a predetermined direction while directing a jet of fluid mainly containing gas onto the fiber web 100, which is placed on the topside of a netted supporting member 260. Grooves 1, convex portions 2, and second convex portions 22 are formed when fluid mainly containing gas is directed thereupon; however, formation thereof may be changed as needed by the shape of the blowing nozzles 913 for the fluid mainly containing gas in the nonwoven fabric manufacturing device 90.

As illustrated in FIG. 14, it is possible to form the nonwoven fabric 150, for example, by adjusting the intervals between the blowing nozzles 913 from which fluid mainly containing gas is directed. For example, it is possible to form the second convex portions 22 with the height in a thickness direction (TD) lower than that of the convex portions 2 by making the intervals between the blowing nozzles 913 narrower than the intervals between the blowing nozzles 913 of the first embodiment. In addition, it is possible to form convex portions with the heights in the thickness direction (TD) higher than that of the convex portions 2 by making the intervals between the blowing nozzles 913 wider than the intervals between the blowing nozzles 913 of the first embodiment. Moreover, the nonwoven fabric 150 in which the convex portions 2 and the second convex portions 22 are arranged alternately in parallel sandwiching the grooves 1 is formed by arranging the blowing nozzles 913 so that narrower intervals and wider intervals alternate in the intervals. It is possible to form the intervals of the blowing nozzles 913 as needed according to the heights of the convex portions 2 and the arrangement of the second convex portions 22 of the nonwoven fabric to be formed.

The nonwoven fabric 150 according to this embodiment may be manufactured by means of the aforementioned nonwoven fabric manufacturing device 90. The description of the manufacturing method for the nonwoven fabric 110 and the nonwoven fabric manufacturing device 90 according to the first embodiment may serve as a reference for a manufacturing method and the like of the nonwoven fabric 150 by means of the nonwoven fabric manufacturing device 90.

### 2-5. Sixth Embodiment

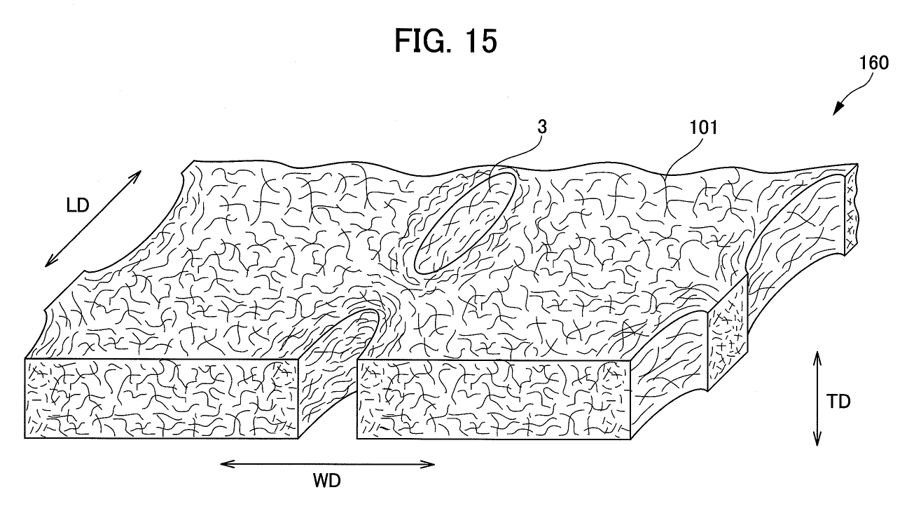

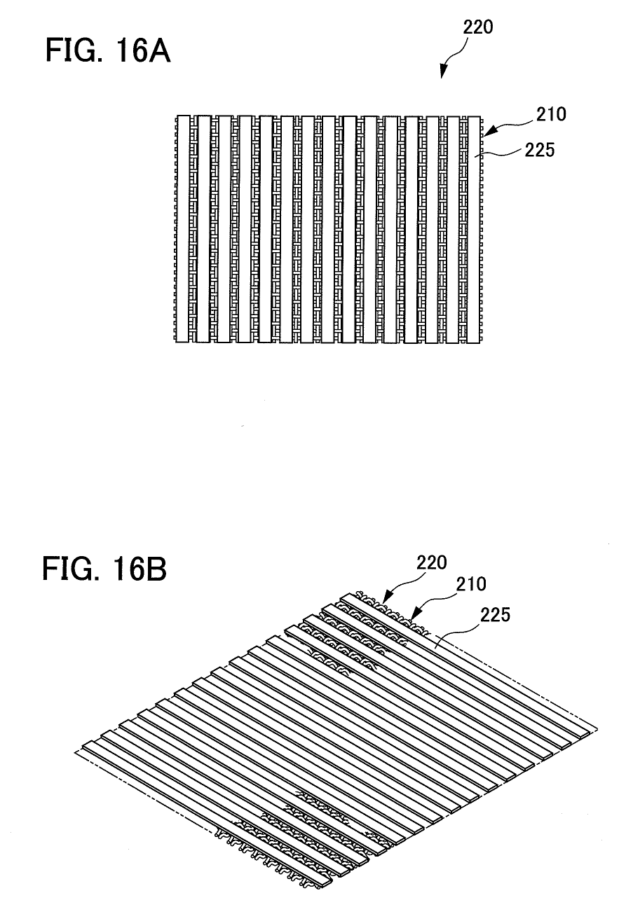

A nonwoven fabric according to the sixth embodiment of the present invention is described below while referring to FIGS. 15 and 16.

As illustrated in FIG. 15, a nonwoven fabric 160 according to this embodiment is a nonwoven fabric on which a plurality of openings 3 is formed. It is different from the first embodiment in that the convex portions and grooves are not formed, and fiber orientation, fiber density, and fiber basis weight are adjusted in the periphery of the openings 3. The differences are mainly described below.

### 2-5-1. Nonwoven Fabric

As illustrated in FIG. 15, a nonwoven fabric 160 according to this embodiment is a nonwoven fabric in which a plurality of openings 3 is formed.

A plurality of the openings 3 is formed at substantially equal intervals in a longitudinal direction (LD) in a fiber web 100, or in a direction in which fluid mainly containing gas is directed onto the fiber web 100 or a fiber assembly, for example. In addition, a plurality of the openings 3 is formed at substantially equal intervals in a width direction (WD) in the fiber web 100. In this case, for example, the openings 3 may be formed at various intervals both in the longitudinal direction (LD) and in the width direction (WD).

The plurality of respective openings 3 is formed in a substantially circular or substantially elliptical shape. In addition, fibers 101 in the plurality of respective openings 3 are orientated along the periphery of the openings 3. Basically, the ends of the openings 3 in the longitudinal direction (LD) are orientated in a direction intersecting the longitudinal direction (LD), and the side portions of the openings 3 in the longitudinal direction (LD) are orientated in the longitudinal direction (LD).

In addition, since the fibers 101 in the periphery of the plurality of openings 3 are shifted to the periphery of the openings 3 by fluid mainly containing gas directed thereupon, the fiber density in the periphery of the openings 3 is adjusted to be higher than the fiber density in the other regions.

Moreover, the nonwoven fabric 160 is formed so that the fiber density on a side (underside) which is placed on a supporting member 220 (FIG. 16) is higher than the fiber density on a side (topside) opposite to the side on which the supporting member is placed. This is because the fibers 101 with a degree of freedom in the fiber web 100 gather on the supporting member 220 side due to the force of gravity or pressure of the directed fluid mainly containing gas.

### 2-5-2. Manufacturing Method

A manufacturing method according to this embodiment is similar to the manufacturing method according to the first embodiment; however, it is different in that grooves and convex portions are not formed in the nonwoven fabric 160. The differences are mainly described below.

A supporting member 220 as shown in FIG. 16, for example, may be exemplified as a breathable supporting member used for forming the nonwoven fabric 160 shown in FIG. 15. Basically, a supporting member is configured by placing a plurality of narrow members 225 substantially in parallel at predetermined intervals on the topside of a netted supporting member 210 of FIG. 4. The narrow members 225 are impervious members and prevent fluid mainly containing gas directed from above from passing downwardly through. In addition, the flow direction of the fluid mainly containing gas directed onto the narrow members 225 is changed.

Then, it is possible to manufacture the nonwoven fabric 160 by placing the fiber web 100 on the supporting member 220, shifting the supporting member 220 in a predetermined direction while supporting the fiber web 100, and continuously directing a jet of fluid thereupon from the topside of the fiber web 100 being shifted.

More specifically, grooves and convex portions of the first embodiment are not formed by continuously directing a jet of fluid mainly containing gas thereupon; however, the openings 3 are formed by means of fluid mainly containing gas, which is directed fluid mainly containing gas and/or directed fluid mainly containing gas that passes through the fiber web 100, whose flow direction is changed by the narrow members 225.

It should be noted that the amount of fluid mainly containing gas directed onto the nonwoven fabric 160 should be enough to allow for the shift of the fibers 101 in the fiber web 100 in regions onto which the fluid mainly containing gas is directed. In this case, suctioning (drawing) does not have to be carried out by an air intake unit 915, which draws the fluid mainly containing gas downward to the supporting member 220. It is preferable that suctioning (drawing) from below the supporting member 220 is performed to prevent the shape of the formed fiber web 100 from being damaged by fluid mainly containing gas that rebounds off of the supporting member 220. It is preferable that the amount of suctioning (drawing) fluid mainly containing gas is enough to prevent the fiber web 100 from being pressed (crushed) by the supporting member 220.

Furthermore, in addition to the case of forming only the openings 3 as mentioned above, concavity and convexity may be crushed by wrapping it in a roll or the like after forming the concavity, convexity and the openings 3 by directing a jet of fluid mainly containing gas thereupon.

In addition, as another manufacturing method, a flat plate without vents may be used as a supporting member. More specifically, it is possible to manufacture the nonwoven fabric 160 by placing the fiber web 100 on a flat plate, shifting the supporting member in a predetermined direction while supporting the fiber web 100, and continuously directing a jet of fluid mainly containing gas thereupon.

Since the entire flat plate is impervious, an intermittently directed fluid mainly containing gas along with the fluid mainly containing gas whose flow direction is changed form the openings 3. In other words, the openings 3 are formed in regions onto which fluid mainly containing gas is directed.

The nonwoven fabric 160 according to this embodiment may be manufactured by means of the aforementioned nonwoven fabric manufacturing device 90. The description of the manufacturing method for the nonwoven fabric 110 and the nonwoven fabric manufacturing device 90 according to the first embodiment may serve as a reference for a manufacturing method and the like of the nonwoven fabric 160 by means of the nonwoven fabric manufacturing device 90.

### 3. WORKING EXAMPLES

### 3-1. First Working Example

### <Fiber Structure>

Mixing of fibers A, which are coated with a hydrophilic oil solution with average fineness of 3.3 dtex and average fiber length of 51 millimeters, with fibers B, which are different from the fibers A in being coated with a water-repellent oil solution, is used for a core-in-sheath structure of high-density polyethylene and polyethylene terephthalate. The mixing ratio between fibers A and fibers B is 70:30, and a fiber assembly whose fiber basis weight is adjusted to be 40 g/m² is used.

### <Manufacturing Conditions>

A plurality of blowing nozzles 913 of FIG. 9 with a 1.0 millimeter diameter and a 6.0 millimeter pitch are formed. In addition, the shape of the blowing nozzles 913 is a perfect circle, and the cross-sectional shape of an air-pipe which is communicated with the blowing nozzles 913 of an blowing unit 910 and through which fluid mainly containing gas passes has a cylindrical shape. The width of the blowing unit 910 is 500 millimeters. Hot air is directed onto a fiber web with the aforementioned structure under conditions where the temperature is 80 degrees centigrade and the air volume is 600 liters/minute.

A carding machine is used to open and form a fiber web with the aforementioned fiber structure at a rate of 20 meters/minute, and the fiber web is cut so that the width is 450 millimeters. The fiber web is then conveyed on a 20-mesh breathable net at a rate of 3 meters/minute. In addition, hot air is directed onto the fiber web at the aforementioned manufacturing conditions by means of the blowing unit 910 and the blowing nozzles 913, with less hot air than the hot air volume directed from below the breathable net being suctioned (drawn). Afterwards, the fiber web is conveyed through an oven for approximately 30 seconds with the temperature set at 130 degrees centigrade and the hot air volume at 10 Hertz while being conveyed on the breathable net.

### <Results>

Central portions: Ratio of fibers orientated in the longitudinal direction (LD) to fibers orientated in the width direction (WD) is 68:22, fiber basis weight is 48 g/m², thickness is 3.5 millimeters, fiber density is 0.01 g/cm³, width of each central portion is 2.5 millimeters, and pitch is 6.1 millimeters.
Laterally orientated portions: Ratio of fibers orientated in the longitudinal direction (LD) to fibers orientated in the width direction (WD) is 35:65, fiber basis weight is 37 g/m², thickness is 3.4 millimeters, fiber density is 0.01 g/cm³, width of each laterally orientated portion is 1.4 millimeters, and pitch is 6.1 millimeters.
Longitudinally orientated portions: Ratio of fibers orientated in the longitudinal direction (LD) to fibers orientated in the width direction (WD) is 72:28, fiber basis weight is 49 g/m², thickness is 3.5 millimeters, fiber density is 0.01 g/cm³, width of each longitudinally orientated portion is 1.1 millimeters, and pitch is 3.6 millimeters.
Shape: The longitudinally orientated portions are formed on both sides of the central portions. In addition, the central portions, the longitudinally orientated portions, and the laterally orientated portions are formed so as to continuously extend in the longitudinal direction (LD), and to alternate in the width direction (WD). Moreover, fiber density is adjusted to gradually increase from the surface side to the underside of the nonwoven fabric. In particular, the fiber orientation of the longitudinally orientated portions is adjusted to be orientated in the longitudinal direction (LD) on the whole. In addition, the height of the nonwoven fabric in the thickness direction (TD) is formed to be almost fixed.

### 3-2. Second Working Example

### <Fiber Structure>

The fiber structure is the same as that of the first working example.

### <Manufacturing Conditions>

With the design of the aforementioned blowing unit 910 and blowing nozzles 913, hot air is directed at the conditions where the temperature is 105 degrees centigrade and airflow is 1000 liters/minute, with almost the same amount or slightly more hot air than the hot air volume directed from below the breathable net is suctioned (drawn).

### <Results>

Central portions: Ratio of fibers orientated in the longitudinal direction (LD) to fibers orientated in the width direction (WD) is 73:27, fiber basis weight is 48 g/m², thickness is 3.5 millimeters, fiber density is 0.02 g/cm³, width of each central portion is 2.5 millimeters, and pitch is 6.1 millimeters.
Grooves: Ratio of fibers orientated in the longitudinal direction (LD) to fibers orientated in the width direction (WD) is 29:71, fiber basis weight is 17 g/m², thickness is 1.8 millimeters, fiber density is 0.009 g/cm³, width of each groove is 1.4 millimeters, and pitch is 6.1 millimeters.
Side portions: Ratio of fibers orientated in the longitudinal direction (LD) to fibers orientated in the width direction (WD) is 81:19, fiber basis weight is 49 g/m², thickness is 3.2 millimeters, fiber density is 0.03 g/cm³, width of each side portion is 1.1 millimeters, and pitch is 3.6 millimeters.
Shape: The side portions are formed on both sides of the central portions, and convex portions are formed from the central portions and the side portions. In addition, grooves are formed along the convex portions. Moreover, the convex portions and the grooves are formed so as to extend along the longitudinal direction (LD), and to alternate in the width direction (WD). Furthermore, fiber density is adjusted to increase from the surface side to the underside of the nonwoven fabric, and fiber orientation in the grooves is adjusted to be orientated in the longitudinal direction (LD) on the whole.

### 3-3. Third Working Example

### <Fiber Structure>

The fiber structure is the same as that of the first working example.

### <Manufacturing Conditions>

A fiber web formed with the aforementioned fiber structure is conveyed through an oven for approximately 30 seconds with the temperature set at 130 degrees centigrade and hot air volume at 10 Hz while being supported on the aforementioned breathable net. Hot air is then directed at the conditions where the temperature is 120 degrees centigrade and airflow is 2200 liters/minute using the aforementioned blowing unit 910 and the blowing nozzles 913 just after (after approximately two seconds) being conveyed out the oven.

### <Results>

Central portions: Ratio of fibers orientated in the longitudinal direction (LD) to fibers orientated in the width direction (WD) is 64:36, fiber basis weight is 37 g/m², thickness is 3.3 millimeters, fiber density is 0.01 g/cm³, width of each central portion is 1.9 millimeters, and pitch is 6.1 millimeters.
Grooves: Ratio of fibers orientated in the longitudinal direction (LD) to fibers orientated in the width direction (WD) is 32:71, fiber basis weight is 23 g/m², thickness is 1.1 millimeters, fiber density is 0.02 g/cm³, width of each groove is 2.1 millimeters, and pitch is 6.1 millimeters.
Side portions: Ratio of fibers orientated in the longitudinal direction (LD) to fibers orientated in the width direction (WD) is 72:28, fiber basis weight is 39 g/m², thickness is 3.2 millimeters, fiber density is 0.01 g/cm³, width of each side portion is 1.5 millimeters, and pitch is 3.6 millimeters.
Shape: Convex portions and grooves are formed.

### 3-4. Fourth Working Example

### <Fiber Structure>

The fiber structure is the same as that of the first working example.

### <Manufacturing Conditions>

Airflow is directed at the conditions where the temperature is 80 degrees centigrade and airflow is 1800 liters/minute with the aforementioned design of the blowing unit 910 and the blowing nozzles 913. The fiber web with the aforementioned fiber structure is then needle punched by means of needles, which are aligned in a zigzag at a pitch of 5 millimeters in the longitudinal direction (LD) and at a pitch of 5 millimeters in the width direction, at a rate of 3 meters/minute in the longitudinal direction (LD) for 200 times/minute to semi-interlace the fibers with each other. Afterwards, airflow is directed thereupon under the manufacturing conditions by means of the aforementioned blowing unit 910 and the blowing nozzles 913. In addition, almost the same amount or slightly more hot air than the hot air volume is suctioned (drawn) from below the breathable net at the same time.

### <Results>

Central portions: Ratio of fibers orientated in the longitudinal direction (LD) to fibers orientated in the width direction (WD) is 69:31, fiber basis weight is 45 g/m², thickness is 2.5 millimeters, fiber density is 0.02 g/cm³, width of each central portion is 2.4 millimeters, and pitch is 5.7 millimeters.
Grooves: Ratio of fibers orientated in the longitudinal direction (LD) to fibers orientated in the width direction (WD) is 35:65, fiber basis weight is 27 g/m², thickness is 1.9 millimeters, fiber density is 0.01 g/cm³, width of each groove is 1.0 millimeters, and pitch is 5.7 millimeters.
Side portions: Ratio of fibers orientated in the longitudinal direction (LD) to fibers orientated in the width direction (WD) is 75:25, fiber basis weight is 45 g/m², thickness is 2.3 millimeters, fiber density is 0.02 g/cm³, width of each side portion is 0.8 millimeters, and pitch is 4.0 millimeters.
Shape: Convex portions and grooves are sequentially formed so as to extend in the longitudinal direction (LD). In addition, the convex portions and the grooves are partially intermingled downwards and are formed so as to alternate in the width direction (WD).

### 4. APPLICATIONS

As applications of the present invention, a top sheet and the like of an absorbent article such as a sanitary napkin, a liner, a diaper, and the like, for example, may be exemplified. In this case, convex portions may be formed either on a skin side or an underside; however, if convex portions are formed on the skin side, it is possible to make it difficult for the user to feel moistness due to body fluid since the contact area with the skin decreases. In addition, it may be used as an intermediate sheet between the top sheet of the absorbent article and an absorber. It may be difficult to cause reverse flow from an absorber since the contact area with the top sheet or the absorber decreases. Moreover, it may be used as a side sheet of an absorbent article, outer surface (outer back) of a diaper, a female hook-and-loop fastener material, and the like. Furthermore, it may be used for various applications, such as a wiper for removing dust and grime adhered to floors or a body, a mask, and a breast feeding pad.

### 5. COMPONENTS

Components are described below in detail.

### 5-1. Components Pertinent to Nonwoven Fabric

### 5-1-1. Fiber Assembly

A fiber assembly is formed in a substantially sheet shape, and is in the state where the fibers constituting the fiber assembly have a degree of freedom. In other words, it is a fiber assembly having a degree of inter-fiber freedom. In this case, the degree of inter-fiber freedom means a degree allowing the fibers constituting a fiber web or fiber assembly to shift freely by fluid mainly containing gas. The fiber assembly may be formed by ejecting mixed fibers of a plurality of fibers mixed so as to form fiber layers of a predetermined thickness. In addition, it may be formed by ejecting a plurality of different fibers, respectively, so as to form fiber layers by stacking several times.

A fiber web formed by a carding method or fiber web before solidification of heat-sealed fibers may be exemplified as the fiber assembly of the present invention. In addition, a web formed by an air-laid method or fiber web before solidification of heat-sealed fibers may be exemplified. Moreover, a fiber web embossed by a point bond method before solidification of heat-sealing may also be exemplified. Furthermore, a fiber assembly subjected to fiber formation by a spun-bond method before embossing, or embossed fiber assembly before solidification of heat-sealing may be exemplified. In addition, a fiber web which is formed and semi-interlaced by a needle-punch method may also be exemplified. Moreover, a fiber web which is formed and semi-interlaced by a spun-lace method may also be exemplified. Furthermore, a fiber web subjected to fiber forming by a melt-blown method before inter-fiber solidification of heat-sealing may also be exemplified. Additionally, a fiber web before inter-fiber solidification by a solvent formed by a solvent bonding method may be exemplified.

A fiber assembly with fibers easily realigned by air (gas) flow may be exemplified preferably by a fiber web formed by a carding method using relatively long fibers, more preferably by a web before heat-sealing having high inter-fiber freedom and formed only by interlacing. In addition, it is preferable to use a through-air method which heat-seals thermoplastic fibers included in the fiber assembly through oven processing (heat processing) using a predetermined heater or the like to make the nonwoven fabric while keeping the shapes after grooves (concavity and convexity) and the like are formed by a plurality of air (gas) flows.

### 5-1-2. Fibers

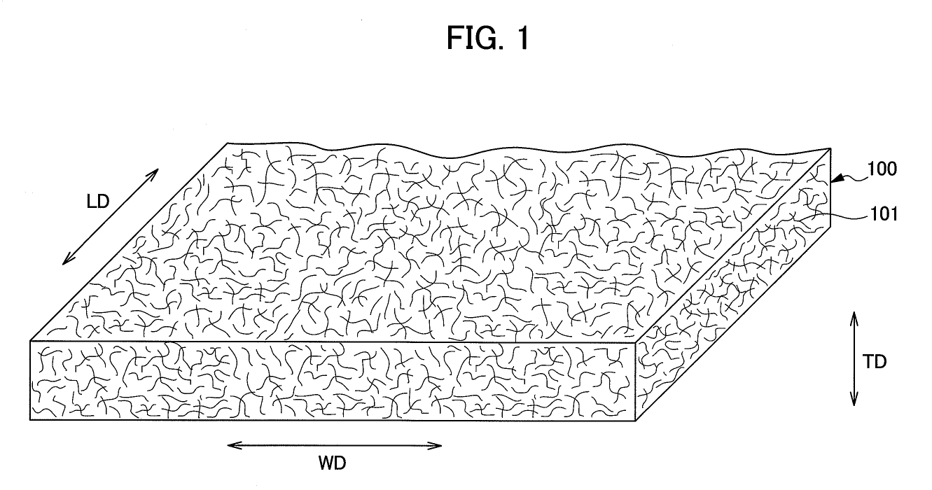

Thermoplastic resin such as low-density polyethylene, high-density polyethylene, linear polyethylene, polypropylene, polyethylene terephthalate, modified polyethylene, modified polyethylene terephthalate, nylon, polyamide, and the like may be given as fibers constituting a fiber assembly (e.g., the fibers 101 constituting the fiber web 100 shown in FIG. 1), for example, or each of these resins by itself or compound fibers thereof may also be given.

A core-in-sheath type having a higher melting point for core components than sheath components, core-in-sheath bias-core type, and side-by-side type having different melting points for left and right components may be given as compound shapes when fibers are compounded. In addition, a hollow type, or a compound shape of different types such as flat, Y type, and C type is available. Moreover, three-dimensional crimped fibers that are potentially crimped or overtly crimped, or split fibers which split due to physical load such as water flow, heat, or embossing may be mixed in the fibers constituting the fiber assembly.

In addition, it is possible to compound predetermined overtly crimped fibers or potentially crimped fibers for forming a three-dimensional crimped shape. In this case, a three-dimensional crimped shape is a shape such as a spiral shape, a zigzag shape, or an ohmic shape, and while fiber orientation is in a planar direction on the whole, it is partially orientated in the thickness direction. This makes the buckling strength of the fibers themselves work in the thickness direction, and thus, it becomes difficult for the bulk to be crushed even if external pressure is applied. Moreover, of these, if fibers are in a spiral shape, they attempt to return to the original shape when external pressure is released; thus, even if the bulk is somewhat crushed due to excessive external pressure, it becomes easy to return to the original thickness.

The overtly crimped fiber is a generic term for fibers whose shape is given through mechanical crimping or whose core-in-sheath structure is biased core type, or which have already been crimped by a side-by-side method or the like. Potentially crimped fibers are those in which crimps generate through heating.

Mechanical crimping is crimping which allows control of the generation of crimps in continuous linear spun fibers through the difference in peripheral velocity of line speed, heat, and the application of force, and allows for an increase in buckling strength against external pressure as the number of crimps in each unit length increases. For example, it is preferable that the number of crimps be within a range from 10 to 35 per inch, and more preferably 15 to 30 per inch.

Fibers whose shape is given by thermal shrinkage are fibers which are constituted with more than two resins having different melting points and are three-dimensionally crimped since the thermal shrinkage rate changes due to differences in the melting point when heated. Bias-core type of a core-in-sheath structure and side-by-side type having different melting points for left and right components may be given as the compound shape of a fiber cross section. A range of 5 to 90%, even of 10 to 80% may be exemplified as a preferable value of the thermal shrinkage rate of such fibers.

A method of measuring thermal shrinkage rate is by (1) forming a web of 200 g/m² with 100% of the fibers to be measured, (2) cutting a sample of 250×250 millimeters, (3) leaving the sample for five minutes inside an oven at 145 degrees centigrade (418.15 K), (4) measuring length after shrinkage, and (5) then calculating a thermal shrinkage rate from differences in length before and after shrinkage.

If the nonwoven fabric is used as a surface sheet, it is preferable that the fineness is in a range of 1.1 to 8.8 dtex when considering the intrusion of fluid and the feel, for example.

If the nonwoven fabric is used as a surface sheet, cellulosic liquid hydrophilic fibers such as pulp, chemical pulp, rayon, acetate, natural cotton, or the like may be included as fibers constituting the fiber assembly to also absorb, for example, a small amount of menstrual blood, sweat, and the like, which remain on the skin. However, cellulosic fibers are difficult to eject once fluid is absorbed; thus, a case of mixing in a range of 0.1 to 5% by mass against the entirety may be exemplified as a preferred pattern.

If the nonwoven fabric is used as a surface sheet, a hydrophilic solution, a water-repellent solution, or the like may be milled in or coated onto the aforementioned hydrophobic synthetic fibers when considering the intrusion of fluid and a rewet back. In addition, hydrophilic property may be given through a corona treatment or a plasma treatment. Moreover, water-repellent fibers may be included. In this case, water-repellent fibers are fibers which have been subjected to a well-known water-repellant treatment.

In addition, an inorganic filler such as titanium oxide, barium sulfate, calcium carbonate or the like may be included in order to increase the whitening property. In the case of compound fibers of core-in-sheath type, it may be included only in cores or also in sheaths.

In addition, as mentioned above, a fiber web formed by a carding method which uses relatively long fibers allows for the realignment of fibers by airflow, and it is preferable to use a through-air method which heat-seals thermoplastic fibers by an oven treatment (heat treatment) to make a nonwoven fabric while maintaining the shape after grooves (concavity and convexity) and the like are formed by a plurality of air (gas) flows. As for fibers suitable for this manufacturing method, it is preferable that fibers of core-in-sheath structure or side-by-side structure in order to heat-seal intersection of fibers are used, and it is even further preferable that fibers of core-in-sheath structure which allow absolute heat-sealing of cores are used. In particular, it is preferable that core-in-sheath compound fibers constituted with polyethylene terephthalate and polyethylene or core-in-sheath compound fibers constituted with polypropylene and polyethylene are used. Those fibers may be used individually, or in combination of two or more types. In addition, it is preferable that the fiber length is from 20 to 100 millimeters, particularly from 35 to 65 millimeters.

### 5-2. Components Pertinent to Nonwoven Fabric Manufacturing Device

### 5-2-1. Fluid Mainly Containing Gas

A gas adjusted to room temperature or a predetermined temperature, or an aerosol, which is the gas including solid or liquid particles, may be exemplified as the fluid mainly containing gas of the present invention.

Air, nitrogen, or the like, for example, may be exemplified as the gas. In addition, the gas includes fluid moisture such as water vapor.

An aerosol is a gas within which fluid or solid is distributed; examples are given below. It is possible to exemplify, for example, gas within which is distributed an ink for coloring, a softening agent such as silicon for further softening, a hydrophilic or water-repellent activator for preventing electrification and controlling wetting property, titanium oxide for increasing fluidic energy, an inorganic filler such as barium sulfate, a powder bond such as polyethylene for increasing fluidic energy and enhancing irregularity form-keeping property in heat treatment, an antihistamic agent such as diphenhydramine hydrochloride, isopropyl-methylphenol for preventing itching, a humectant, a bactericidal substance, or the like. In this case, the solid includes gelatinous aerosols.

The temperature of the fluid mainly containing gas may be adjusted as needed. It is possible to adjust it as needed according to the property of the fibers constituting a fiber assembly or a shape of a nonwoven fabric to be manufactured.

In this case, to favorably shift fibers constituting a fiber assembly, it is preferable that the temperature of the fluid mainly containing gas to be somewhat high since the degree of freedom of fibers constituting the fiber assembly is increased. In addition, if thermoplastic fibers are included in the fiber assembly, it is possible to configure it such that the thermoplastic fibers placed in regions or the like onto which fluid mainly containing gas is directed are softened or melted, and hardened again by setting the temperature of the fluid mainly containing gas to a temperature which allows softening of the thermoplastic fibers.

This keeps the shape of the nonwoven fabric by directing the fluid mainly containing gas thereupon, for example. In addition, a certain amount of strength, for example, which prevents a fiber assembly (nonwoven fabric) from coming apart when the fiber assembly is shifted by means of a predetermined shifting means, is given.

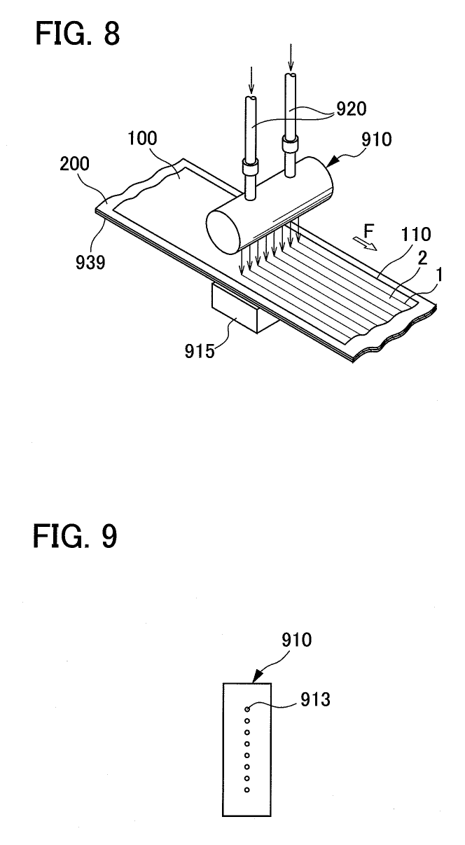

The flow rate of fluid mainly containing gas may be adjusted as needed. A fiber web 100 which is mainly constituted of core-in-sheath fibers with the sheath made of high-density polyethylene and core made of polyethylene terephthalate, fiber length of 20 to 100 millimeters, preferably 35 to 65 millimeters, fineness of 1.1 to 8.8 dtex, preferably 2.2 to 5.6 dtex, uses fibers with a fiber length of 20 to 100 millimeters, preferably 35 to 65 millimeters in the case of opening by a carding method, uses fibers with fiber length of 1 to 5 millimeters, preferably 3 to 20 millimeters in the case of opening by an air-laid method, and is adjusted to be 10 to 1000 g/m², preferably 15 to 100 g/m², may be exemplified as a specific example of a fiber assembly having a degree of inter-fiber freedom. As conditions for the fluid mainly containing gas, a case where hot air at a temperature of 15 to 300 degrees centigrade (from 288.15 K to 573.15 K), preferably 100 to 200 degrees centigrade (from 373.15 K to 473.15 K) is directed onto the fiber web 100 at the conditions of air volume of 3 to 50 L/minute per opening, preferably 5 to 20 L/minute per opening in an blowing unit 910 on which a plurality of blowing nozzles 913 as shown in FIG. 8 or FIG. 9, for example, are formed (blowing nozzles 913: diameter of 0.1 to 30 millimeters, preferably 0.3 to 10 millimeters; pitch of 0.5 to 20 millimeters, preferably 3 to 10 millimeters; shape of a perfect circle, an ellipse, or a rectangle) may be exemplified. For example, if the fluid mainly containing gas is directed under the aforementioned conditions, a fiber assembly which allows for the fiber components to change their position and orientation is one of advantageous fiber assemblies of the present invention. It is possible to form the nonwoven fabric shown in FIGS. 2 and 3 by manufacturing under such fiber and manufacturing conditions. It is possible to provide dimensions and fiber basis weights of the grooves 1 and the convex portions 2 within the following ranges. In the case of the grooves 1, thickness is within a range of 0.05 to 10 millimeters, preferably 0.1 to 5 millimeters, width is within a range of 0.1 to 30 millimeters, preferably 0.5 to 5 millimeters, and fiber basis weight is within a range of 2 to 900 g/m², preferably 10 to 90 g/m². In the case of the convex portions 2, thickness is within a range of 0.1 to 15 millimeters, preferably 0.5 to 10 millimeters, width is within a range of 0.5 to 30 millimeters, preferably 1.0 to 10 millimeters, and fiber basis weight is within a range of 5 to 1000 g/m², preferably 10 to 100 g/m². In addition, a nonwoven fabric may be manufactured approximately within the aforementioned numerical ranges; however, it is not limited thereto.

### 5-2-2. Breathable Supporting Member

A supporting member with a substantially planar or substantially curved shaped side by which the fiber web 100 is supported and a substantially flat surface of a substantially planar or substantially curved shaped side may be exemplified as a breathable supporting member. A flat or cylindrical shape, for example, may be exemplified as the substantially flat or substantially curved shape. In addition, substantially flat means that the side itself of the supporting member on which the fiber web 100 is placed is not formed into concavity and convexity or the like. More specifically, a supporting member with a net of the netted supporting member 210 which is not formed into concavity and convexity or the like may be exemplified.

A flat supporting member or a cylindrical supporting member may be exemplified as the breathable supporting member, for example. More specifically, the aforementioned breathable supporting member 210 and the supporting member 220 may be exemplified.

In this case, the breathable supporting member 200 may be arranged in the nonwoven fabric manufacturing device 90 so as to be detachable. This allows for arrangement of the breathable supporting member 200 as needed according to the desired nonwoven fabric. In other words, the breathable supporting member 200 in the nonwoven fabric manufacturing device 90 may be replaced with another breathable supporting member selected from a plurality of different breathable supporting members.

Netted portions of the netted supporting member 210 shown in FIG. 4 or the supporting member 220 shown in FIG. 16 are described below. As these breathable reticular portions, a breathable net which is woven into plain-woven fabric, twilled fabric, satin, double cloth, spiral cloth, or the like, using string of resin such as polyester, polyphenylene sulfide, nylon, conductive monofilament, or the like, or string made of a metal such as stainless steel, copper, aluminum, or the like may be exemplified.

In this case, air permeability of this breathable net may be partially changed by partially changing the weaving method, string size, or string shape. More specifically, breathable mesh woven into spiral cloth using polyester string, or breathable mesh woven into spiral cloth using flat string and circular string made of stainless steel may be exemplified.

### 5-2-3. Directing Means

For example, the intervals of concave portions (grooves), the heights of the convex portions 2, and the like of concavity and convexity to be formed may be adjusted by adjusting the blowing unit 910 so that the orientation of the fluid mainly containing gas is changeable. In addition, it is possible to adjust the shape of grooves and the like as needed to be vermiculated (wavy or zigzag) or another shape by configuring the orientation of the aforementioned fluid to be automatically changeable. Moreover, shapes and forming patterns of the grooves and openings may be adjusted as needed by adjusting the amount and duration of ejection of the fluid mainly containing gas. The directing angle of the fluid mainly containing gas onto the fiber web 100 may be perpendicular, or it may be orientated at a predetermined angle in a line flow direction or a shifting direction F, or it may be orientated at a predetermined angle in a direction opposite to the line flow direction in the shifting direction F of the fiber web 100.

1. A nonwoven fabric having a first direction and a second direction orthogonal to the first direction, comprising:
a plurality of first regions;
a plurality of second regions which are formed along both sides of the plurality of respective first regions; and
a plurality of third regions which are formed on sides opposite to the plurality of respective first regions in the plurality of respective second regions, and between the plurality of respective second regions adjacent to each other, wherein
the plurality of respective first regions have a higher content ratio of fibers orientated in the second direction than the plurality of respective third regions, and
the plurality of respective second regions have a higher content ratio of fibers orientated in the first direction than the plurality of respective third regions.

2. The nonwoven fabric according to claim 1, wherein
the content ratio of fibers orientated in the first direction in the plurality of respective third regions is from 40% to 80%,
the content ratio of fibers orientated in the first direction in the plurality of respective first regions is 45% or less, and at least 10% lower than the content ratio of fibers orientated in the first direction in the plurality of respective third regions, and
the content ratio of fibers orientated in the first direction in the plurality of respective second regions is 55% or more, and at least 10% more than the content ratio of fibers orientated in the first direction in the plurality of respective third regions.

3. The nonwoven fabric according to claim 1, wherein the content ratio of fibers orientated in the second direction in the plurality of respective first regions is at least 55%.

4. The nonwoven fabric according to claim 2, wherein the content ratio of fibers orientated in the second direction in the plurality of respective first regions is at least 55%.

5. The nonwoven fabric according to claim 1, wherein
a fiber basis weight in the plurality of respective first regions is from 3 to 150 g/m²,
a fiber basis weight in the plurality of respective second regions is from 20 to 280 g/m², and
a fiber basis weight in the plurality of respective third regions is from 15 to 250 g/m².

6. The nonwoven fabric according to claim 1, wherein
a fiber density in the plurality of respective first regions is at most 0.18 g/cm³,
a fiber density in the plurality of respective second regions is at most 0.40 g/cm³, and
a fiber density in the plurality of respective third regions is at most 0.20 g/cm³.

7. The nonwoven fabric according to claim 1, wherein the respective heights in a thickness direction in the plurality of first regions, the plurality of second regions, and the plurality of third regions in the nonwoven fabric are substantially equal.

8. The nonwoven fabric according to claim 1, wherein
a plurality of grooves, and
a plurality of convex portions, which are formed so as to be adjacent to the plurality of respective grooves, are formed in the nonwoven fabric,
the plurality of respective first regions constitutes the plurality of respective grooves,
the plurality of respective second regions constitutes the side portions of the plurality of convex portions, and
the plurality of respective third regions constitutes the central portions in the plurality of convex portions.

9. The nonwoven fabric according to claim 2, wherein
a plurality of grooves, and
a plurality of convex portions, which are formed so as to be adjacent to the plurality of respective grooves, are formed in the nonwoven fabric,
the plurality of respective first regions constitutes the plurality of respective grooves,
the plurality of respective second regions constitutes the side portions of the plurality of convex portions, and
the plurality of respective third regions constitutes the central portions in the plurality of convex portions.

10. The nonwoven fabric according to claim 8, wherein
the heights of the grooves in the nonwoven fabric in a thickness direction are at most 90% of the heights of the central portions in the convex portions, and
the heights of the side portions in the convex portions is at most 95% of the heights of the central portions in the convex portions.

11. The nonwoven fabric according to claim 8, wherein a fiber basis weight in the plurality of respective grooves is at most 90% of an average fiber basis weight in the plurality of respective convex portions.

12. The nonwoven fabric according to claim 8, wherein the heights of the plurality of respective convex portions adjacent to each other sandwiching the plurality of respective grooves differ.

13. The nonwoven fabric according to claim 8, wherein a top portion of the plurality of respective convex portions are substantially flat.

14. The nonwoven fabric according to claim 8, wherein a plurality of regions protruding to a side opposite to a protrusion direction of the convex portions is formed on a side opposite to a side on which the plurality of grooves and the plurality of convex portions in the nonwoven fabric are formed.

15. The nonwoven fabric according to claim 8, wherein a plurality of openings is formed in the plurality of respective first regions.

16. The nonwoven fabric according to claim 1, wherein a plurality of openings is formed in the plurality of respective first regions.

17. The nonwoven fabric according to claim 15, wherein fibers in the periphery of the plurality of respective openings are orientated so as to be along the peripheries of the plurality of respective openings.

18. The nonwoven fabric according to claim 16, wherein fibers in the periphery of the plurality of respective openings are orientated so as to be along the peripheries of the plurality of respective openings.

19. The nonwoven fabric according to claim 1, wherein the nonwoven fabric is mixed with water-repellent fibers.

20. The nonwoven fabric according to claim 1, comprising wavy undulations in the first direction.
